(19) United States
(12) Patent Application Publication
(10) Pub. No.: US 2026/0024014 A1
(43) Pub. Date: Jan. 22, 2026

(54) IMPROVING ACCURACY OF MACHINE LEARNING OPERATIONS BY COMPENSATING FOR LOWER PRECISION WITH SCALE SHIFTING

(71) Applicant: INTEL CORPORATION, Santa Clara, CA (US)

(72) Inventors: Pujiang He, Shanghai (CN); Kshitij Doshi, Tempe, AZ (US)

(73) Assignee: INTEL CORPORATION, Santa Clara, CA (US)

(21) Appl. No.: 18/995,619

(22) PCT Filed: Sep. 30, 2022
(86) PCT No.: PCT/CN2022/123651

§ 371 Date: Jan. 16, 2025

(51) Int. Cl. G06N 20/00

(52) U.S. Cl. CPC G06N 20/00

(57) ABSTRACT

Disclosed is a technical solution for improving accuracy of operations of machine learning by compensating for lower precision with scale shifting. An example non-transitory computer readable medium comprises instructions that, when executed, cause a machine to at least identify a first precision data type and a second precision data type associated with execution of a machine-learning model, the first precision data type to have a first data precision greater than a second data precision of the second precision data type, determine at least one scale factor to be applied to first weights of the machine-learning model, the first weights based on the first precision data type, and convert the first weights to second weights based on a multiplication of the first weights and the at least one scale factor, the second weights based on the second precision data type.

### FIELD OF THE DISCLOSURE

This disclosure relates generally to operations (e.g., dot product operations) in Machine Learning (ML) and, more particularly, to improving accuracy of ML operations by compensating for lower precision with scale shifting.

### BACKGROUND

Operations (e.g., dot product operations) performed in massive volumes are an element of Artificial Intelligence (AI), Machine Learning (ML), and/or general scientific computations. Hardware vendors promote acceleration of these operations by providing new instructions (e.g., Advanced Vector Extensions (AVX), Advanced Matrix Extensions (AMX)) and/or specialized function units, and software vendors implement the new instructions and/or specialized units to further make algorithmic changes, data layout changes, fuse operations to increase cache efficiencies and other computing resources related performance.

### BRIEF DESCRIPTION OF THE DRAWINGS

FIG. 1 is an illustration of an example electronic system including an example accelerator compiler to configure example acceleration circuitry based on an acceleration operation to be executed by the acceleration circuitry.

FIG. 2 is a block diagram of an example implementation of the accelerator compiler of FIG. 1.

FIG. 3 is an illustration of an example conventional convolution operation that may be executed by the example acceleration circuitry of FIGS. 1 and/or 2.

FIG. 4 illustrates a bit-wise binary representation of an FP32 value.

FIG. 5 illustrates an example enumeration process of selection for a scale factor, as performed by the example scale factor determination circuitry of FIG. 2.

FIG. 6 shows an example comparative accuracy graph for example operations using FP32 values, BF16 values, and scaled BF16 values.

FIG. 7 illustrates an example accuracy percent table for example operations using FP32 values, BF16 values, a first technique of scaled BF16 values, and a second technique of scaled BF16 values.

FIGS. 8-11 are flowcharts representative of example machine readable instructions and/or example operations that may be executed by example processor circuitry to implement the acceleration circuitry of FIGS. 1 and/or 2.

FIG. 12 is a block diagram of an example processing platform including processor circuitry structured to execute the example machine readable instructions and/or the example operations of FIGS. 8-11 to implement the acceleration circuitry of FIGS. 1 and/or 2.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 8-11) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

Notwithstanding the foregoing, in the case of a semiconductor device, “above” is not with reference to Earth, but instead is with reference to a bulk region of a base semiconductor substrate (e.g., a semiconductor wafer) on which components of an integrated circuit are formed. Specifically, as used herein, a first component of an integrated circuit is “above” a second component when the first component is farther away from the bulk region of the semiconductor substrate than the second component.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In some examples disclosed herein, a Convolutional Neural Network (CNN) model is used. Using a CNN model enables weight sharing (e.g., reducing the number of weights that must be learned by the model), which reduces model training time and computation cost. In general, machine learning models/architectures that are suitable to use in the example approaches disclosed herein will be Neural Networks (NN), Deep Neural Networks (DNN), and/or Recurrent Neural Networks (RNN). However, other types of machine learning models could additionally or alternatively be used such as Support Vector Machines (SVM), Long Term Short Memory (LSTM), Gated Recurrent Units (GRU), etc.

In general, implementing an ML/AI system involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labeling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs).

In examples disclosed herein, ML/AI models are trained using stochastic gradient descent. However, any other training algorithm may additionally or alternatively be used. In examples disclosed herein, training is performed until an acceptable amount of error has been reached. In examples disclosed herein, training may be performed at the electronic system 102 (e.g., on the ML model(s) 124). Training is performed using hyperparameters that control how the learning is performed (e.g., a learning rate, a number of layers to be used in the machine learning model, etc.). In examples disclosed herein, hyperparameters that control a precision of values used as operands are used. Such hyperparameters are selected by, for example, manually and/or using statistical (random) sampling. In some examples, re-training may be performed. Such re-training may be performed in response to an accuracy metric not satisfying a threshold value.

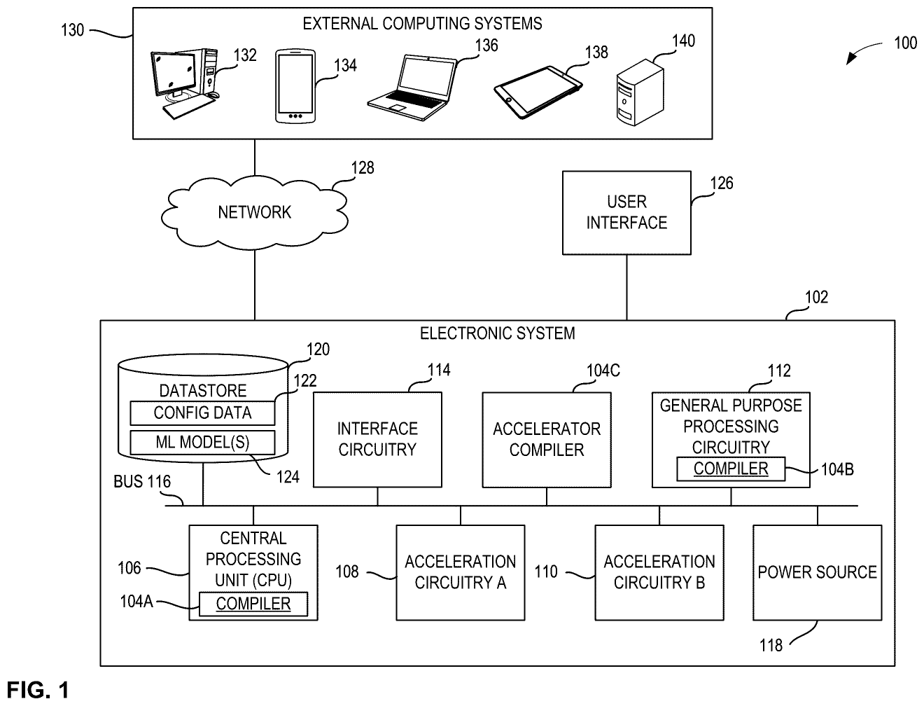

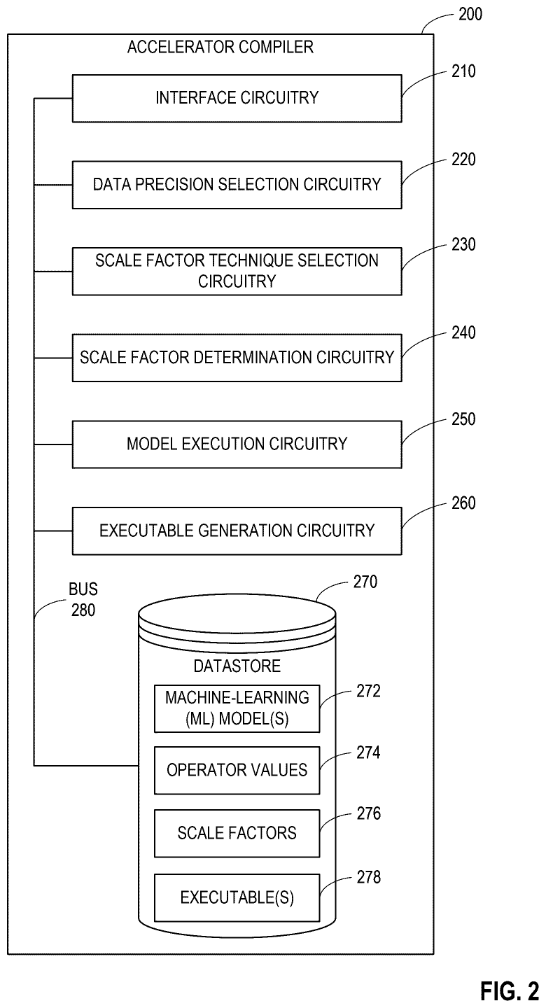

Training is performed using training data. In examples disclosed herein, the training data may originate from a datastore (e.g., example datastore 270 explained further in conjunction with FIG. 2). Because supervised training is used, the training data is labeled. Labeling is applied to the training data by an accelerator compiler (e.g., example accelerator compiler 104A-C explained further in conjunction with FIG. 1). In some examples, the training data is pre-processed using, for example, an interface (e.g., example interface circuitry 114 explained further in conjunction with FIG. 1). In some examples, the accelerator compiler 104A-C of FIG. 1 sub-divides the training data into a first portion of data for training the machine-learning model(s) 124, and a second portion of data for validating the example machine-learning (ML) model(s) 124 of FIG. 1.

Once training is complete, the model is deployed for use as an executable construct that processes an input and provides an output based on the network of nodes and connections defined in the model. The model is stored at a datastore (e.g., example datastore 270 of FIG. 2). The model may then be executed by example model execution circuitry 250 (explained further in conjunction with FIG. 2). In some examples, the platform on which the model is executed may have particular operand precision and/or accuracy constraints.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

There exist many different ways in which an operand and/or value (e.g., integer, scalar, fractional, etc.) may be represented on a particular computing device, with each representation characterized by a variably-sized memory footprint and/or differing precision qualities. For example, a single-precision floating-point format (referred to herein as “FP32” format) is most commonly used in machine-learning (ML) and artificial intelligence (AI) applications, particularly in Deep Neural Networks (DNNs). The FP32 format is characterized by 1 sign bit, 8 exponent bits, and 23 mantissa bits, which lends a capability for high precision due to a higher-than-average available bit-storage. However, the FP32 format is accordingly further characterized by a larger memory footprint, with 32 total bits for each value represented using that format. Therefore, in situations in which large volumes of values and/or data must be operated upon and/or stored in a memory of a particular computing device, remote server, etc., a decrease in machine performance is observed.

Brain floating-point format (referred to herein as “BF16” format), which may also be used in applications of ML and AI-involved computations, is characterized by 1 sign bit, 8 exponent bits, and 7 mantissa bits, which, in comparison with the FP32 format, indicates a lower precision capability due to a lower availability of bit-storage. The BF16 format, however, by using 16 fewer mantissa bits for storage in memory, is accordingly further characterized by a smaller memory footprint, lending an advantage in its capability for better (e.g., more efficient) performance of a computing device and/or less resource-intensive computing.

For many types of computations (e.g., scientific computations), working with lower precision values (such as BF16 values) in favor of better (e.g., more efficient and/or less resource-intensive) computing is quite acceptable. For example, an advertising engine may occasionally achieve a lower click-through rate (CTR) (e.g., indicating a lower number of users who click on an advertisement instead of scrolling past) due to a small classification inaccuracy. The classification inaccuracies may be related, in some cases, to a reduction in the number of floating point bits (e.g., mantissa bits) used to describe the value, with the lower number of bits indicating a lower level of precision (e.g., similar to a number of digits listed after a decimal point for fractional values), and the lower level of precision leads to a frequency of classification error that is regarded acceptable within the advertising industry.

However, for many other types of computations (e.g., cumulative dot product operations), accuracy cannot be afforded as a tradeoff for faster and/or better performance. In particular, when Artificial Intelligence (AI) and/or High Performance Computing (HPC) techniques are used in areas that require high-accuracy operation such as, for example, finance, robotics, pharmaceuticals, radiology, etc., low-precision operand and/or value representation formats such as BF16 are not preferred over high-precision, yet more memory-intensive value representation formats such as FP32. In these examples, higher-precision operation is preferred over efficiency of computing.

Therefore, increasing the precision afforded by a typically lower-precision value representation format (e.g., BF16) while retaining the less resource-intensive characteristics of such a format is the desired approach to increasing efficiency of computing and/or operation of electronic systems (e.g., example electronic system 102, example external electronic systems 130 explained further in conjunction with FIG. 1).

Current approaches to using lower-precision data representation formats focus on frequent retraining of the machine-learning (ML) and/or artificial intelligence (AI) model in which they are utilized, with extensive software testing used to establish that an accuracy loss resulting from a shift to lower-precision value representations (e.g., BF16) falls within a range of acceptability. Additional approaches use higher-precision value representations (e.g., FP32) during the training phase of the ML/AI model and lower-precision value representations (e.g., BF16) during the inference phase of the ML/AI model. These approaches similarly utilize extensive software testing to ensure that the associated accuracy loss routinely falls within the acceptable range.

The extensive software retraining and/or testing employed and/or required by these approaches often produces unsatisfactory, delayed, and/or unclear recommendations (e.g., particularly during the inference phase of the ML/AI model). Furthermore, the frequent repetition of this precision vs. accuracy testing required to ensure optimum model results is resource-intensive, computationally-expensive, and/or challenging, particularly in instances where test datasets and/or training datasets are large in volume and/or are frequently-evolving. That is, the software testing required to ensure model results fall within an acceptable range of accuracy may cause validation cycles to become prolonged. Moreover, decisions to be made between using low-precision or high-precision data representation formats become increasingly complex if new training and/or re-training of the model improves accuracy, but the use of lower-precision data representation formats reduces accuracy. Additionally, the current approaches described herein may only be applicable in a limited number of situations due to a foreseeable and/or observed risk of an incorrect cutoff decision being made, particularly when the triage performed by a model employing a lower-precision data representation format (e.g., BF16) produces an incorrect confidence score. In short, the current approaches frequently over-complicate the process of deploying ML/AI models by complicating the training phase and/or the post-training testing/inference phase.

Example methods for utilizing lower-precision data representation formats while maintaining high accuracy of ML/AI model results focus on scaling of values and/or operands from high-precision data representation formats (e.g., FP32) to lower-precision data representation formats (e.g., BF16) using a weighting factor, then reverse-scaling (e.g., from BF16 to FP32 format) their resulting value (e.g., post-operation and/or computation) by the same order of magnitude (e.g., the same weighting factor). Such a method reduces the amount of information stored and/or contained in the lower bits of the mantissa of the value representation format (e.g., with the BF16 representation format characterized by 16 fewer mantissa bits), thus effectively reducing the memory footprint and/or computational demand associated with each value. In operations performed by the ML/AI model, such as dot product operations, in which frequent accumulation of values is performed in high volume, the cumulative information that is stored in the lower-order bits of the FP32-representation mantissa is effectively captured via a scaling and/or weighting factor applied to the values upon conversion to their BF16 representation, thus reducing frequency of truncation error and/or loss of information/accuracy associated with the conversion of these value formats. That is, for example, re-scaling (e.g., de-scaling) of the BF16-represented values effectively corrects any potential truncation error observed by the elimination of the 16 lower-order mantissa bits by uniformly updating those same mantissa bits upon completion of the given computation and/or operation (e.g., dot product operation) back to their original FP32 format, thus effectively eliminating any bias, error, and/or need for extensive software testing to ensure model conformance within an acceptable range of accuracy of results.

Furthermore, removing a loss-of-accuracy concern as a barrier to use of lower-precision data representation formats such as BF16 enables a massive reduction in computational cost, effort, and/or resource expenditure (e.g., through reduction of an overall memory footprint). In examples disclosed herein, while FP32 and BF16 data representation formats are used to describe scaling and de-scaling between higher-precision and lower-precision data representation formats, any other type of data representation formats may be employed to perform bit width reductions.

FIG. 1 is an illustration of an example computing environment 100 including an example electronic system 102, which includes an example accelerator compiler 104A-C to configure an ML/AI accelerator to execute scaling operations as convolution operations, matrix multiplication operations (e.g., MatMul), etc. to achieve improved accelerator efficiency and performance. In some examples, the accelerator compiler 104A-C obtains an output from a machine-learning framework (e.g., a NN framework) and compiles the output for implementation on the accelerator based on the scaling operation to be executed and/or otherwise performed by the accelerator.

The electronic system 102 of the illustrated example of FIG. 1 includes an example central processing unit (CPU) 106, a first example acceleration circuitry (ACCELERATION CIRCUITRY A) 108, a second example acceleration circuitry (ACCELERATION CIRCUITRY B) 110, an example general purpose processing circuitry 112, an example interface circuitry 114, an example bus 116, an example power source 118, and an example datastore 120. In this example, the datastore 120 includes example configuration data (CONFIG DATA) 122 and example machine-learning model(s) (ML MODEL(S)) 124. Further depicted in the illustrated example of FIG. 1 are an example user interface 126, an example network 128, and example external electronic systems 130.

In some examples, the electronic system 102 is a system on a chip (SoC) representative of one or more integrated circuits (ICs) (e.g., compact ICs) that incorporate components of a computer or other electronic system in a compact format. For example, the electronic system 102 may be implemented with a combination of one or more programmable processors, hardware logic, and/or hardware peripherals and/or interfaces. Additionally or alternatively, the example electronic system 102 of FIG. 1 may include memory, input/output (I/O) port(s), and/or secondary storage. For example, the electronic system 102 includes the acceleration compiler 104A-C, the CPU 106, the first acceleration circuitry 108, the second acceleration circuitry 110, the general purpose processing circuitry 112, the interface circuitry 114, the bus 116, the power source 118, the datastore 120, the memory, the I/O port(s), and/or the secondary storage all on the same substrate (e.g., silicon substrate, semiconductor-based substrate, etc.). In some examples, the electronic system 102 includes digital, analog, mixed-signal, radio frequency (RF), or other signal processing functions.

In the illustrated example of FIG. 1, the first acceleration circuitry 108 is an artificial intelligence (AI) accelerator. For example, the first acceleration circuitry 108 may be implemented by a hardware accelerator configured to accelerate AI tasks or workloads, such as NNs (e.g., artificial neural networks (ANNs)), machine vision, machine learning, etc. In some examples, the first acceleration circuitry 108 may implement an ML/AI accelerator (e.g., a sparse hardware accelerator). In some examples, the first acceleration circuitry 108 may implement a vision processing unit (VPU) to effectuate machine or computer vision computing tasks, train and/or execute a physical neural network, and/or train and/or execute a neural network. In some examples, the first acceleration circuitry 108 may train and/or execute a convolution neural network (CNN), a deep neural network (DNN), an ANN, a recurrent neural network (RNN), etc., and/or a combination thereof.

In the illustrated example of FIG. 1, the second acceleration circuitry 110 is a graphics processing unit (GPU). For example, the second acceleration circuitry 110 may be a GPU that generates computer graphics, executes general-purpose computing, etc. In some examples, the second acceleration circuitry 110 is another instance of the first acceleration circuitry 108. In some such examples, the electronic system 102 may provide portion(s) of AI/ML workloads to be executed in parallel by the first acceleration circuitry 108 and the second acceleration circuitry 110.

The general purpose processing circuitry 112 of the example of FIG. 1 is a programmable processor, such as a CPU or a GPU. Alternatively, one or more of the first acceleration circuitry 108, the second acceleration circuitry 110, and/or the general purpose processing circuitry 112 may be a different type of hardware such as a digital signal processor (DSP), an application specific integrated circuit (ASIC), a programmable logic device (PLD), and/or a field programmable logic device (FPLD) (e.g., a field-programmable gate array (FPGA)).

In the illustrated example of FIG. 1, the interface circuitry 114 is hardware that may implement one or more interfaces (e.g., computing interfaces, network interfaces, etc.). For example, the interface circuitry 114 may be hardware, software, and/or firmware that implements a communication device (e.g., a network interface card (NIC), a smart NIC, a gateway, a switch, etc.) such as a transmitter, a receiver, a transceiver, a modem, a residential gateway, a wireless access point, and/or a network interface to facilitate exchange of data with external machines (e.g., computing devices of any kind) via the network 128. In some examples, the communication is effectuated via a Bluetooth® connection, an Ethernet connection, a digital subscriber line (DSL) connection, a wireless fidelity (Wi-Fi) connection, a telephone line connection, a coaxial cable system, a satellite system, a line-of-site wireless system, a cellular telephone system, an optical connection (e.g., a fiber-optic connection), etc. For example, the interface circuitry 114 may be implemented by any type of interface standard, such as a Bluetooth® interface, an Ethernet interface, a Wi-Fi interface, a universal serial bus (USB), a near field communication (NFC) interface, and/or a peripheral component interconnect express (PCIe) interface.

The electronic system 102 includes the power source 118 to deliver power to hardware of the electronic system 102. In some examples, the power source 118 may implement a power delivery network. For example, the power source 118 may implement an alternating current-to-direct current (AC/DC) power supply. In some examples, the power source 118 may be coupled to a power grid infrastructure such as an AC main (e.g., a 110 volt (V) AC grid main, a 220V AC grid main, etc.). Additionally, or alternatively, the power source 118 may be implemented by a battery. For example, the power source 118 may be a limited energy device, such as a lithium-ion battery or any other chargeable battery or power source. In some such examples, the power source 118 may be chargeable using a power adapter or converter (e.g., an AC/DC power converter), a wall outlet (e.g., a 110 V AC wall outlet, a 220 V AC wall outlet, etc.), a portable energy storage device (e.g., a portable power bank, a portable power cell, etc.), etc.

The electronic system 102 of the illustrated example of FIG. 1 includes the datastore 120 to record data (e.g., the configuration data 122, the ML model(s) 124, etc.). The datastore 120 of this example may be implemented by a volatile memory (e.g., a Synchronous Dynamic Random Access Memory (SDRAM), a Dynamic Random Access Memory (DRAM), a RAMBUS Dynamic Random Access Memory (RDRAM), etc.) and/or a non-volatile memory (e.g., flash memory). The datastore 120 may additionally or alternatively be implemented by one or more double data rate (DDR) memories, such as DDR, DDR2, DDR3, DDR4, mobile DDR (mDDR), etc. The datastore 120 may additionally or alternatively be implemented by one or more mass storage devices such as hard disk drive(s) (HDD(s)), compact disk (CD) drive(s), digital versatile disk (DVD) drive(s), solid-state disk (SSD) drive(s), etc. While in the illustrated example, the datastore 120 is illustrated as a single datastore, the datastore 120 may be implemented by any number and/or type(s) of datastores. Furthermore, the data stored in the datastore 120 may be in any data format such as, for example, binary data, comma delimited data, tab delimited data, structured query language (SQL) structures, an executable, etc.

In the illustrated example of FIG. 1, the electronic system 102 is in communication with the user interface 126. For example, the user interface 126 may be implemented by a graphical user interface (GUI), an application user interface, etc., which may be presented to a user on a display device in circuit with and/or otherwise in communication with the electronic system 102. In some such examples, a user (e.g., a developer, an IT administrator, a customer, etc.) controls the electronic system 102, configures, trains, and/or executes the ML model(s) 124, etc., via the user interface 126. Alternatively, the electronic system 102 may include and/or otherwise implement the user interface 126.

In the illustrated example of FIG. 1, the accelerator compiler 104A-C, the CPU 106, the first acceleration circuitry 108, the second acceleration circuitry 110, the general purpose processing circuitry 112, the interface circuitry 114, the power source 118, and the datastore 120 are in communication with one(s) of each other via the bus 116. For example, the bus 116 may be implemented by at least one of an Inter-Integrated Circuit (I2C) bus, a Serial Peripheral Interface (SPI) bus, a Peripheral Component Interconnect (PCI) bus, or a PCIe bus. Additionally, or alternatively, the bus 116 may be implemented by any other type of computing or electrical bus.

In the illustrated example of FIG. 1, the network 128 is the Internet. However, the network 128 of this example may be implemented using any suitable wired and/or wireless network(s) including, for example, one or more data buses, one or more Local Area Networks (LANs), one or more wireless LANs, one or more cellular networks, one or more private networks, one or more public networks, etc. In some examples, the network 128 enables the electronic system 102 to be in communication with one(s) of the external electronic systems 130.

In the illustrated example of FIG. 1, the external electronic systems 130 include and/or otherwise implement one or more electronic (e.g., computing) devices on which the ML model(s) 124 is/are to be executed. In this example, the external electronic systems 130 include an example desktop computer 132, an example mobile device (e.g., a smartphone, an Internet-enabled smartphone, etc.) 134, an example laptop computer 136, an example tablet (e.g., a tablet computer, an Internet-enabled tablet computer, etc.) 138, and an example server 140. In some examples, fewer or more than the external electronic systems 130 depicted in FIG. 1 may be used. Additionally, or alternatively, the external electronic systems 130 may include, correspond to, and/or otherwise be representative of, any other type and/or quantity of computing devices.

In some examples, one or more of the external electronic systems 130 execute one(s) of the ML model(s) 124 to process a computing workload (e.g., an AI/ML workload). For example, the mobile device 134 can be implemented as a cell or mobile phone having one or more processors (e.g., a CPU, a GPU, a VPU, an AI or NN specific processor, etc.) on a single SoC to process an AI/ML workload using one(s) of the ML model(s) 124. In some examples, the desktop computer 132, the laptop computer 136, the tablet computer, and/or the server 140 may be implemented as electronic (e.g., computing) device(s) having one or more processors (e.g., a CPU, a GPU, a VPU, an AI/NN specific processor, etc.) on one or more SoCs to process AI/ML workload(s) using one(s) of the ML model(s) 124. In some examples, the server 140 may implement one or more servers (e.g., physical servers, virtualized servers, etc., and/or a combination thereof) that may implement a data facility, a cloud service (e.g., a public or private cloud provider, a cloud-based repository, etc.), etc., to process AI/ML workload(s) using one(s) of the ML model(s) 124.

In the illustrated example of FIG. 1, the electronic system 102 includes a first accelerator compiler 104A (e.g., a first instance of the accelerator compiler 104A-C), a second accelerator compiler 104B (e.g., a second instance of the accelerator compiler 104A-C), and a third accelerator compiler 104C (e.g., a third instance of the accelerator compiler 104A-C) (collectively referred to herein as the accelerator compiler 104A-C unless specified otherwise). In this example, the first accelerator compiler 104A is implemented by the CPU 106 (e.g., implemented by hardware, software, and/or firmware of the CPU 106).

In the illustrated example of FIG. 1, the second accelerator compiler 104B is implemented by the general purpose processing circuitry 112 (e.g., implemented by hardware, software, and/or firmware of the general purpose processing circuitry 112). In this example, the third accelerator compiler 104C is external to the CPU 106. For example, the third accelerator compiler 104C may be implemented by hardware, software, and/or firmware of the electronic system 102. In some such examples, the third accelerator compiler 104C may be implemented by one or more analog or digital circuit(s), logic circuits, programmable processor(s), programmable controller(s), GPU(s), DSP(s), ASIC(s), PLD(s), and/or FPLD(s)).

In some examples, one or more of the first accelerator compiler 104A, the second accelerator compiler 104B, the third accelerator compiler 104C, and/or portion(s) thereof, may be virtualized, such as by being implemented with one or more containers, one or more virtual resources (e.g., virtualizations of compute, memory, networking, storage, etc., physical hardware resources), one or more virtual machines, etc. In some examples, one or more of the first accelerator compiler 104A, the second accelerator compiler 104B, the third accelerator compiler 104C, and/or portion(s) thereof, may be implemented by different resource(s) of the electronic system 102. Alternatively, the electronic system 102 may not include one or more of the first accelerator compiler 104A, the second accelerator compiler 104B, and/or the third accelerator compiler 104C.

In the illustrated example of FIG. 1, the accelerator compiler 104A-C may compile an AI/ML framework based on the configuration data 122 for implementation on one(s) of the acceleration circuitry 108, 110. In some examples, the configuration data 122 may include AI/ML configuration data (e.g., register configurations, activation data, activation sparsity data, weight data, weight sparsity data, hyperparameters, etc.), a convolution operation to be executed (e.g., a 2-D convolution, a depthwise convolution, a grouped convolution, a dilated convolution, etc.), a non-convolution operation (e.g., an elementwise addition operation), etc., and/or a combination thereof. In some examples, the accelerator compiler 104A-C may compile the AI/ML framework to generate an executable construct that may be executed by the one(s) of the acceleration circuitry 108, 110.

In the illustrated example of FIG. 1, the accelerator compiler 104A-C may instruct, direct, and/or otherwise invoke one(s) of the acceleration circuitrys 108, 110 to execute one(s) of the ML model(s) 124. For example, the ML model(s) 124 may implement AI/ML models. AI, including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the machine-learning model(s) 124 may be trained with data to recognize patterns and/or associations and follow such patterns and/or associations when processing input data such that other input(s) result in output(s) consistent with the recognized patterns and/or associations.

Many different types of machine-learning models and/or machine-learning architectures exist. In some examples, the accelerator compiler 104A-C generates the machine-learning model(s) 124 as neural network model(s). The accelerator compiler 104A-C may invoke the interface circuitry 114 to transmit the machine-learning model(s) 124 to one(s) of the external electronic systems 130. Using a neural network model enables the acceleration circuitry 108, 110 to execute an AI/ML workload. In general, machine-learning models/architectures that are suitable to use in the example approaches disclosed herein include recurrent neural networks. However, other types of machine learning models could additionally or alternatively be used such as supervised learning ANN models, clustering models, classification models, etc., and/or a combination thereof. Example supervised learning ANN models may include two-layer (2-layer) radial basis neural networks (RBN), learning vector quantization (LVQ) classification neural networks, etc. Example clustering models may include k-means clustering, hierarchical clustering, mean shift clustering, density-based clustering, etc. Example classification models may include logistic regression, support-vector machine (SVM) or network, Naive Bayes, etc. In some examples, the accelerator compiler 104A-C may compile and/or otherwise generate one(s) of the machine-learning model(s) 124 as lightweight machine-learning models.

In general, implementing an ML/AI system involves two phases, a learning/training phase and an inference phase. In the learning/training phase, a training algorithm is used to train the machine-learning model(s) 124 to operate in accordance with patterns and/or associations based on, for example, training data. In general, the machine-learning model(s) 124 include(s) internal parameters (e.g., the configuration data 122) that guide how input data is transformed into output data, such as through a series of nodes and connections within the machine-learning model(s) 124 to transform input data into output data. Additionally, hyperparameters (e.g., the configuration data 122) are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, the accelerator compiler 104A-C may invoke supervised training to use inputs and corresponding expected (e.g., labeled) outputs to select parameters (e.g., by iterating over combinations of select parameters) for the machine-learning model(s) 124 that reduce model error. As used herein, “labeling” refers to an expected output of the machine learning model (e.g., a classification, an expected output value, etc.). Alternatively, the accelerator compiler 104A-C may invoke unsupervised training (e.g., used in deep learning, a subset of machine learning, etc.) that involves inferring patterns from inputs to select parameters for the machine-learning model(s) 124 (e.g., without the benefit of expected (e.g., labeled) outputs).

In some examples, the accelerator compiler 104A-C trains the machine-learning model(s) 124 using unsupervised clustering of operating observables. However, the accelerator compiler 104A-C may additionally or alternatively use any other training algorithm such as stochastic gradient descent, Simulated Annealing, Particle Swarm Optimization, Evolution Algorithms, Genetic Algorithms, Nonlinear Conjugate Gradient, etc.

In some examples, the accelerator compiler 104A-C may train the machine-learning model(s) 124 until the level of error is no longer reducing. In some examples, the accelerator compiler 104A-C may train the machine-learning model(s) 124 locally on the electronic system 102 and/or remotely at an external electronic system (e.g., one(s) of the external electronic systems 130) communicatively coupled to the electronic system 102. In some examples, the accelerator compiler 104A-C trains the machine-learning model(s) 124 using hyperparameters that control how the learning is performed (e.g., a learning rate, a number of layers to be used in the machine learning model, etc.). In some examples, the accelerator compiler 104A-C may use hyperparameters that control model performance and training speed such as the learning rate and regularization parameter(s). The accelerator compiler 104A-C may select such hyperparameters by, for example, trial and error to reach an optimal model performance. In some examples, the accelerator compiler 104A-C utilizes Bayesian hyperparameter optimization to determine an optimal and/or otherwise improved or more efficient network architecture to avoid model overfitting and improve the overall applicability of the machine-learning model(s) 124. Alternatively, the accelerator compiler 104A-C may use any other type of optimization. In some examples, the accelerator compiler 104A-C may perform re-training. The accelerator compiler 104A-C may execute such re-training in response to override(s) by a user of the electronic system 102, a receipt of new training data, etc.

In some examples, the accelerator compiler 104A-C facilitates the training of the machine-learning model(s) 124 using training data. In some examples, the accelerator compiler 104A-C utilizes training data that originates from locally generated data. In some examples, the accelerator compiler 104A-C utilizes training data that originates from externally generated data. In some examples where supervised training is used, the accelerator compiler 104A-C may label the training data. Labeling is applied to the training data by a user manually or by an automated data pre-processing system. In some examples, the accelerator compiler 104A-C may pre-process the training data using, for example, an interface (e.g., the interface circuitry 114). In some examples, the accelerator compiler 104A-C sub-divides the training data into a first portion of data for training the machine-learning model(s) 124, and a second portion of data for validating the machine-learning model(s) 124.

Once training is complete, the accelerator compiler 104A-C may deploy the machine-learning model(s) 124 for use as an executable construct that processes an input and provides an output based on the network of nodes and connections defined in the machine-learning model(s) 124. The accelerator compiler 104A-C may store the machine-learning model(s) 124 in the datastore 120. In some examples, the accelerator compiler 104A-C may invoke the interface circuitry 114 to transmit the machine-learning model(s) 124 to one(s) of the external electronic systems 130. In some such examples, in response to transmitting the machine-learning model(s) 124 to the one(s) of the external electronic systems 130, the one(s) of the external electronic systems 130 may execute the machine-learning model(s) 124 to execute AI/ML workloads with at least one of improved efficiency or performance.

Once trained, the deployed one(s) of the machine-learning model(s) 124 may be operated in an inference phase to process data. In the inference phase, data to be analyzed (e.g., live data) is input to the machine-learning model(s) 124, and the machine-learning model(s) 124 execute(s) to create an output. This inference phase can be thought of as the AI “thinking” to generate the output based on what it learned from the training (e.g., by executing the machine-learning model(s) 124 to apply the learned patterns and/or associations to the live data). In some examples, input data undergoes pre-processing before being used as an input to the machine-learning model(s) 124. Moreover, in some examples, the output data may undergo post-processing after it is generated by the machine-learning model(s) 124 to transform the output into a useful result (e.g., a display of data, a detection and/or identification of an object, an instruction to be executed by a machine, etc.).

In some examples, output of the deployed one(s) of the machine-learning model(s) 124 may be captured and provided as feedback. By analyzing the feedback, an accuracy of the deployed one(s) of the machine-learning model(s) 124 can be determined. If the feedback indicates that the accuracy of the deployed model is less than a threshold or other criterion, training of an updated model can be triggered using the feedback and an updated training data set, hyperparameters, etc., to generate an updated, deployed model.

In some examples, the accelerator compiler 104A-C configures one(s) of the acceleration circuitry 108, 110 to execute a convolution operation, such as 2-D convolution operation. For example, the acceleration circuitry 108, 110 may implement a CNN. In some examples, CNNs ingest and/or otherwise process images as tensors, which are matrices of numbers with additional dimensions. For example, a CNN can obtain an input image represented by 3-D tensors, where a first and a second dimension correspond to a width and a height of a matrix and a third dimension corresponds to a depth of the matrix. For example, the width and the height of the matrix can correspond to a width and a height of an input image and the depth of the matrix can correspond to a color depth (e.g., a color layer) or a color encoding of the image (e.g., a Red-Green-Blue (RGB) encoding).

A typical CNN may also receive an input and transform the input through a series of hidden layers. For example, a CNN may have a plurality of convolution layers, pooling layers, and/or fully-connected layers. In some such examples, a CNN may have a plurality of layer triplets including a convolution layer, a pooling layer, and a fully-connected layer. In some examples, a CNN may have a plurality of convolution and pooling layer pairs that output to one or more fully-connected layers. In some examples, a CNN may include 20 layers, 30 layers, etc.

In some examples, the acceleration circuitry 108, 110 may execute a convolution layer to apply a convolution function or operation to map images of an input (previous) layer to the next layer in a CNN. In some examples, the convolution may be three-dimensional (3-D) because each input layer can have multiple input features (e.g., input channels) associated with an input image. The acceleration circuitry 108, 110 may execute the convolution layer to perform convolution by forming a regional filter window in each individual input channel and generating output data or activations by calculating a product of (1) a filter weight associated with the regional filter window and (2) the input data covered by the regional filter window. For example, the acceleration circuitry 108, 110 may determine an output feature of an input image by using the convolution filter to scan a plurality of input channels including a plurality of the regional filter windows.

In some examples, the acceleration circuitry 108, 110 may execute a pooling layer to extract information from a set of activations in each output channel. The pooling layer may perform a maximum pooling operation corresponding to a maximum pooling layer or an average pooling operation corresponding to an average pooling layer. In some examples, the maximum pooling operation may include selecting a maximum value of activations within a pooling window. In some examples, the average pooling operation may include calculating an average value of the activations within the pooling window.

In some examples, the acceleration circuitry 108, 110 may execute a fully-connected layer to obtain the data calculated by the convolution layer(s) and/or the pooling layer(s) and/or classify the data into one or more classes. In some examples, the fully-connected layer may determine whether the classified data corresponds to a particular image feature of the input image. For example, the acceleration circuitry 108, 110 may execute the fully-connected layer to determine whether the classified data corresponds to a simple image feature (e.g., a horizontal line) or a more complex image feature like an animal (e.g., a cat).

In some examples, the accelerator compiler 104A-C may configure one(s) of the acceleration circuitry 108, 110 to execute non-2-D convolution operations as 2-D convolution operations. For example, the accelerator compiler 104A-C may configure the one(s) of the acceleration circuitry 108, 110 to implement a depthwise convolution operation, an elementwise addition operation, a grouped convolution operation, a dilated convolution operation, a custom operation (e.g., a custom convolution, a custom acceleration operation, etc.), etc., as a 2-D convolution operation. In some such examples, the accelerator compiler 104A-C may instruct the one(s) of the acceleration circuitry 108, 110 to internally generate data rather than receive the data from the accelerator compiler 104A-C, the configuration data 122, etc. For example, the accelerator compiler 104A-C may instruct the first acceleration resource to generate at least one of activation sparsity data, weight sparsity data, or weight data based on the acceleration operation to be executed by the first acceleration circuitry 108. In some such examples, the accelerator compiler 104A-C may instruct the one(s) of the acceleration circuitry 108, 110 to execute the one(s) of the ML model(s) 124 based on the data generated by the one(s) of the acceleration circuitry 108, 110, which may be based on a convolution operation to be executed by the one(s) of the acceleration circuitry 108, 110.

FIG. 2 is a block diagram of an example accelerator compiler 200. In some examples, the accelerator compiler 200 of FIG. 2 may implement one or more of the accelerator compiler 104A-C of FIG. 1 to perform scale-shifting of operands to increase computational and/or resource efficiency, along with operation accuracy, while using lower-precision operand values. The accelerator compiler 104A-C of FIG. 2 may be instantiated (e.g., creating an instance of, bring into being for any length of time, materialize, implement, etc.) by processor circuitry such as a central processing unit executing instructions. Additionally, or alternatively, the accelerator compiler 104A-C of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the illustrated example of FIG. 2, the accelerator compiler 200 may configure a hardware accelerator, such as the example interface circuitry 210, example data precision selection circuitry 220, example scale factor technique selection circuitry 230, example scale factor determination circuitry 240, example model execution circuitry 250, example executable generation circuitry 260, an example bus 280, and an example datastore 270, further including example machine-learning (ML) model(s) 272, example operator values 274, example scale factors 276, and example executable(s) 278.

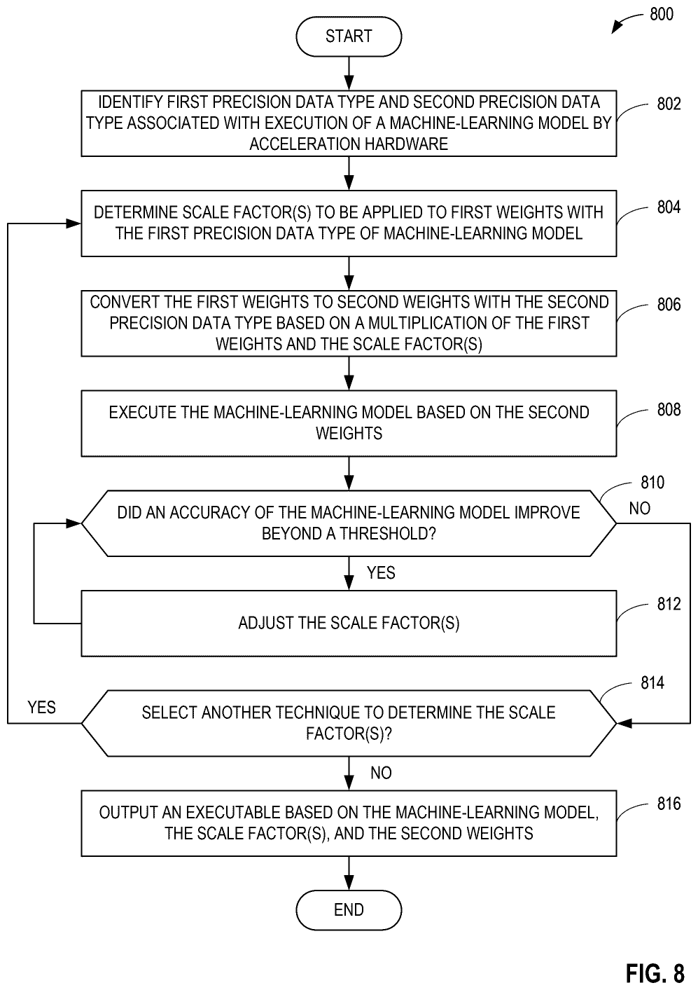

In operation, the example interface circuitry 210 obtains any number of operators (e.g., the operator values 274) to execute a machine-learning (ML) operation (e.g., a dot product operation). In examples disclosed herein, the interface circuitry 210 may obtain the operator values 274 from the example datastore 270. In examples disclosed herein, this source may be any type of database, Internet source, etc. Additionally, in examples disclosed herein, the interface circuitry 210 may receive and/or transmit data (e.g., the operator values 274) to a network or other parts of the electronic system 102 of FIG. 1, such as the acceleration circuitry 108, 110 of FIG. 1. In some examples, the interface circuitry 210 may also be the interface and/or cable from a laptop to a GPU and/or FPGA to configure an operation such as a loading of an image. In some examples, the example interface circuitry 210 is instantiated by processor circuitry executing interface circuitry 210 instructions and/or configured to perform operations such as those represented by the flowcharts of FIGS. 8, 9, 10, and/or 11.

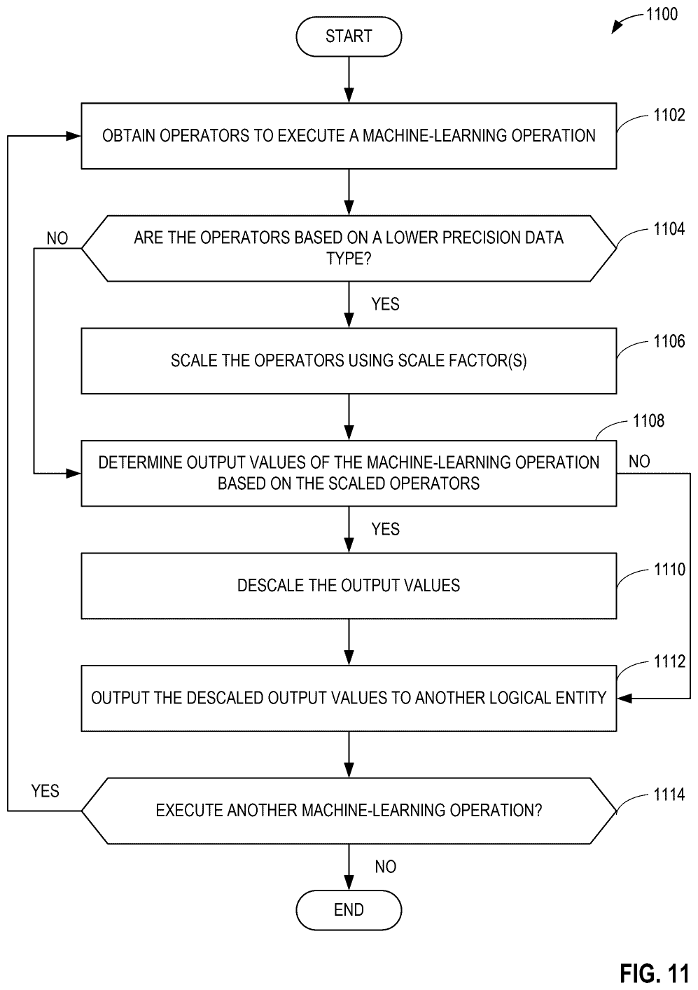

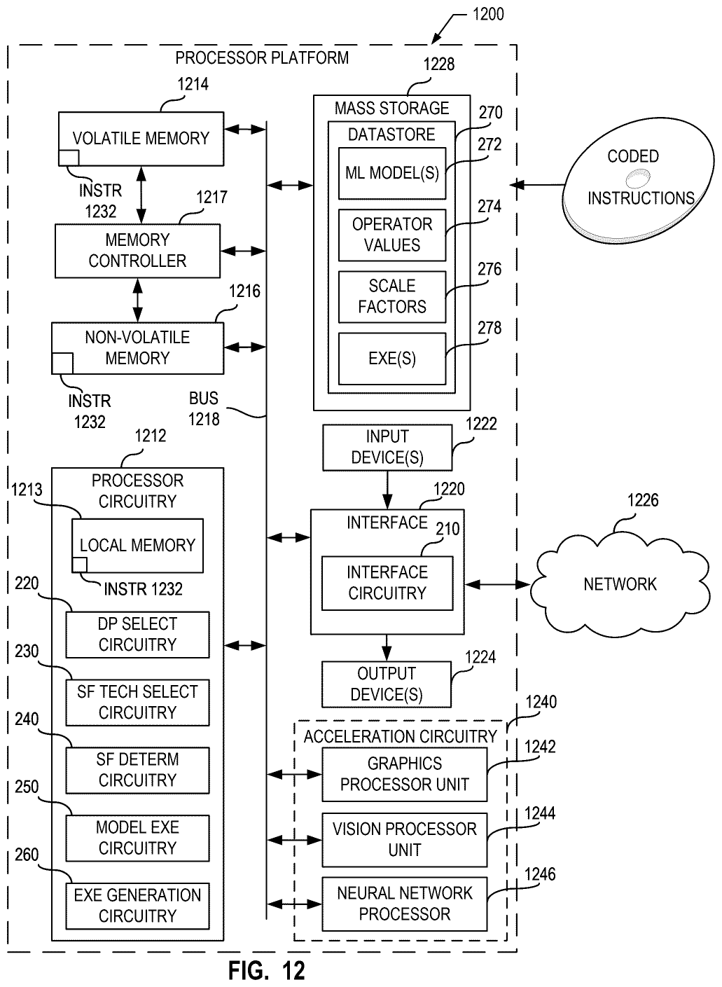

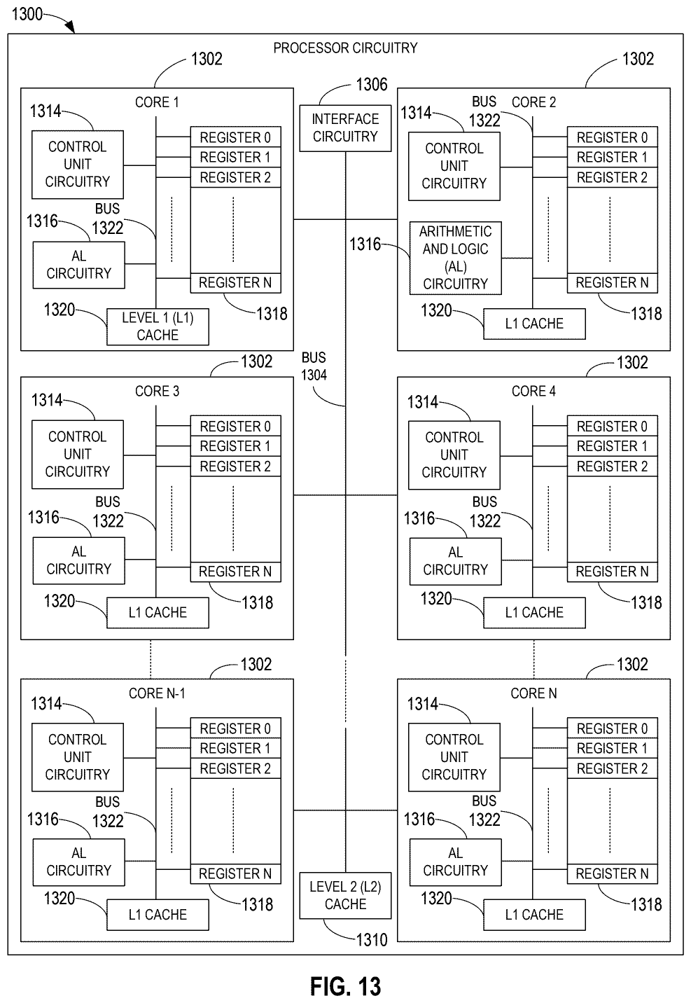

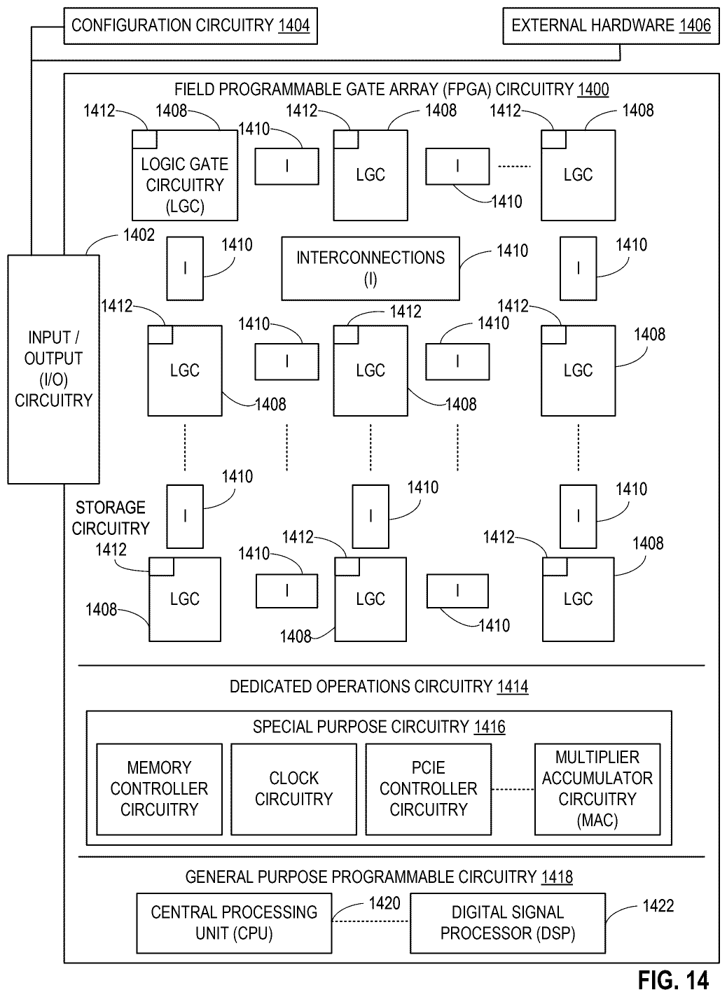

In some examples, the interface circuitry 210 includes means for obtaining any number of operators (e.g., the operator values 274) to execute a machine-learning (ML) operation (e.g., a dot product operation). For example, the means for obtaining any number of operators (e.g., the operator values 274) to execute an ML operation (e.g., a dot product operation) may be implemented by interface circuitry 210. In some examples, the interface circuitry 210 may be instantiated by processor circuitry such as the example processor circuitry 1212 of FIG. 12. For instance, the interface circuitry 210 may be instantiated by the example microprocessor 1300 of FIG. 13 executing machine executable instructions such as those implemented by at least block 1102 of FIG. 11. In some examples, the interface circuitry 210 may be instantiated by hardware logic circuitry, which may be implemented by an ASIC, XPU, or the FPGA circuitry 1400 of FIG. 14 structured to perform operations corresponding to the machine readable instructions. Additionally or alternatively, the interface circuitry 210 may be instantiated by any other combination of hardware, software, and/or firmware. For example, the interface circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example data precision selection circuitry 220 determines both a low-precision data representation type and a high-precision data representation type associated with execution of the ML model for which scaling is to be performed. For example, the data precision selection circuitry 220 may determine an initial format of FP32 for each of the operands and/or values and a scaled format of BF16 to increase computation efficiency. In some examples, the example data precision selection circuitry 220 is instantiated by processor circuitry executing data precision selection circuitry 220 instructions and/or configured to perform operations such as those represented by the flowcharts of FIGS. 8, 9, 10 and/or 11.

In some examples, the data precision selection circuitry 220 includes means for determining both a low-precision data representation type and a high-precision data representation type associated with execution of the ML model for which scaling is to be performed. For example, the means for determining both a low-precision data representation type and a high-precision data representation type associated with execution of the ML model for which scaling is to be performed may be implemented by data precision selection circuitry 220. In some examples, the data precision selection circuitry 220 may be instantiated by processor circuitry such as the example processor circuitry 1212 of FIG. 12. For instance, the data precision selection circuitry 220 may be instantiated by the example microprocessor 1300 of FIG. 13 executing machine executable instructions such as those implemented by at least blocks 802, 1104 of FIGS. 8 and/or 11. In some examples, the data precision selection circuitry 220 may be instantiated by hardware logic circuitry, which may be implemented by an ASIC, XPU, or the FPGA circuitry 1400 of FIG. 14 structured to perform operations corresponding to the machine readable instructions. Additionally, or alternatively, the data precision selection circuitry 220 may be instantiated by any other combination of hardware, software, and/or firmware. For example, the data precision selection circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example scale factor technique selection circuitry 230 performs a pre-processing of data in order to select a scaling technique for the scale factor determination circuitry 240 to employ. That is, for example, the scale factor technique selection circuitry 230 may consider accuracy acceptability constraints, volumes of data, particular operations to be performed, etc. Equation 1 shown below shows an example dot product of two vectors xᵢ and wᵢ (in which all values are represented in FP32 format). Equation 2 similarly shows a BF16 representation x′ᵢ, w′ᵢ of the two vectors from Equation 1 of the same dot product operation.

$${y}_{fp 32} = {\sum }_{i = 0}^{N - 1} {x}_{i} {w}_{i} \qquad Equation 1$$

$${y}_{bf 16} = {\sum }_{i = 0}^{N - 1} {x}_{i}^{′} {w}_{i}^{′} \qquad Equation 2$$

The resulting difference in value between each of the dot product operations may accordingly be represented as shown below in Equation 3. The example scale factor technique selection circuitry 230, in conjunction with the example scale factor determination circuitry 240 selects scaling factors aimed to reduce the value of the resulting difference (Δ) that represents any potential accuracy loss in conversion of the values between high-precision and low-precision data representation formats.

$$Δ = {y}_{fp 32} - {y}_{bf 16} = {\sum }_{i = 0}^{N - 1} {x}_{i} {w}_{i} - {\sum }_{i = 0}^{N - 1} {x}_{i}^{′} {w}_{i}^{′} = {\sum }_{i = 0}^{N - 1} ( {x}_{i}^{′} + {Δ}_{xi} ) ( {w}_{i}^{′} + {Δ}_{wi} ) - {\sum }_{i = 0}^{N - 1} {x}_{i}^{′} {w}_{i}^{′} = {\sum }_{i = 0}^{N - 1} ( {x}_{i}^{′} {Δ}_{wi} + {w}_{i}^{′} {Δ}_{xi} + {Δ}_{xi} {Δ}_{wi} ) \qquad Equation 3$$

To reduce the value of the overall dot product value difference (Δ), the scale factor technique selection circuitry 230 determines a minimization of the sum of x′ᵢΔ_{wi}+w′ᵢΔₓᵢ, through use of a weighting and/or scaling factor to account for any rounding and/or truncation error. In the first term, x′ᵢΔ_{wi}, the inputs x′ᵢ to the ML/AI model are likely to be dynamic during the inference phase, while their associated weight values, w′ᵢ are static values. Therefore, since a single scaling factor Δ_{wi} is applied to all weight values, the effect of this factor in the first term is constant however is constant in the products x′ᵢΔ_{wi}, and therefore, conceivably, if the weights are accordingly re-scaled upon completion of the dot product operation, the value of Δ_{wi} can be greatly reduced, thus reducing its contribution to the overall loss (e.g., difference) value. The second term, w′ᵢΔₓᵢ is difficult to reduce as effectively as the first, since the scale factor technique selection circuitry 230 cannot accurately predict each of the unknown inputs to the ML/AI model prior to the inference phase. However, through training of the model with weights and/or scaling factors by the scale factor technique selection circuitry 230 and/or the example scale factor determination circuitry 240, the weights can be regularized to smaller values (e.g., by penalizing for large wᵢ values), thus effectively reducing the overall difference value (e.g., indicating a reduced loss of accuracy). In some examples, the example scale factor technique selection circuitry 230 is instantiated by processor circuitry executing scale factor technique selection circuitry 230 instructions and/or configured to perform operations such as those represented by the flowcharts of FIGS. 8, 9, 10, and/or 11.

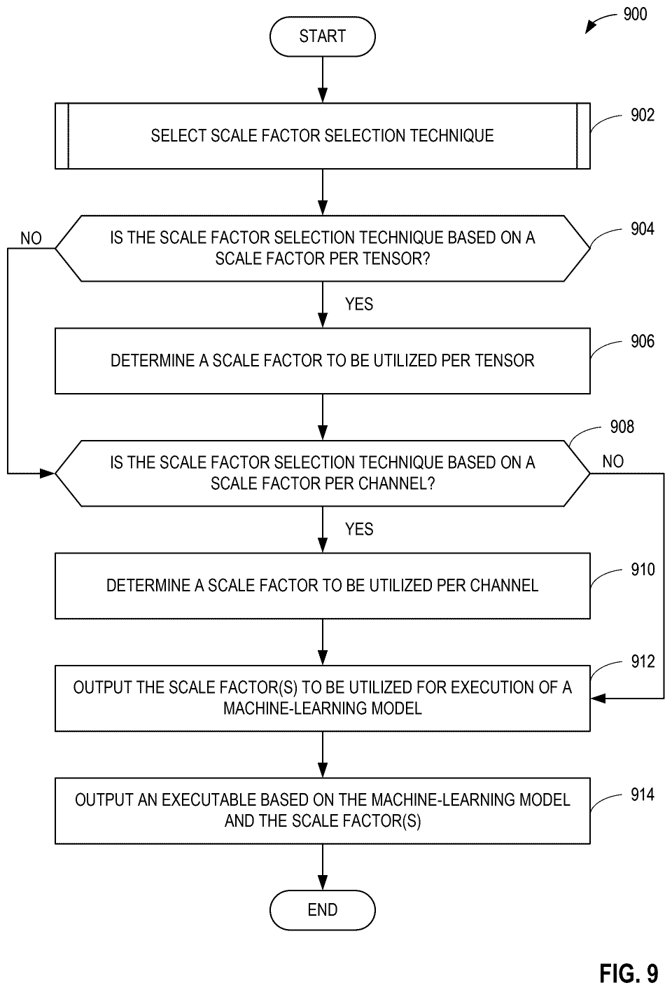

In some examples, the scale factor technique selection circuitry 230 includes means for selecting a scaling technique for the scale factor determination circuitry 240 to employ to execute a machine-learning (ML) operation (e.g., a dot product operation) while maintaining high accuracy. For example, the means for selecting a scaling technique for the scale factor determination circuitry 240 to employ to execute a machine-learning (ML) operation (e.g., a dot product operation) while maintaining high accuracy may be implemented by scale factor technique selection circuitry 230. In some examples, the scale factor technique selection circuitry 230 may be instantiated by processor circuitry such as the example processor circuitry 1212 of FIG. 12. For instance, the scale factor technique selection circuitry 230 may be instantiated by the example microprocessor 1300 of FIG. 13 executing machine executable instructions such as those implemented by at least blocks 814, 902, 904, 908, and/or 1002-1012 of FIGS. 8, 9, and/or 10. In some examples, the scale factor technique selection circuitry 230 may be instantiated by hardware logic circuitry, which may be implemented by an ASIC, XPU, or the FPGA circuitry 1400 of FIG. 14 structured to perform operations corresponding to the machine readable instructions. Additionally, or alternatively, the scale factor technique selection circuitry 230 may be instantiated by any other combination of hardware, software, and/or firmware. For example, the scale factor technique selection circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example scale factor determination circuitry 240 determines a scaling factor to be used in conversion and/or de-conversion of the high-precision data representation format (e.g., FP32) to the low-precision data representation format (e.g., BF16), based on the pre-processing performed by the scale factor technique selection circuitry 230. In examples disclosed herein, the scaling and/or de-scaling is performed by the scale factor determination circuitry 240 by first calculating a target value associated with each of the FP32-represented operands, with the target value obtained by masking a number of lower-order bits to reduce an associated memory footprint. In examples disclosed herein, the lower 16 mantissa bits (e.g., least significant bits) of each of the FP32-represented values would be masked (e.g., set of zero) in order to determine each target value, as shown in example Equation 4 below (wherein WFP32 represents an original FP32-represented value, and t_{FP32} represents its corresponding target value with the lower 16 mantissa bits masked).

$${w}_{FP 32} = 0 x 3 f 937 fff \\ {t}_{FP 32} = 0 x 3 f 9 e 0000 \qquad Equation 4$$

Once each respective target value has been determined by the scale factor technique selection circuitry 230, a scale factor(s) is determined by way of Equation 5, as shown below, with minimal to no-observed precision loss associated with the target BF16-represented value.

$$s * w = ( \frac{{t}_{FP 32}}{{w}_{FP 32}} ) * {w}_{FP 32} = {t}_{BF 16} \qquad Equation 5$$

In examples disclosed herein, the exponent and/or sign bits associated with each of the BF16 and/or FP32 are unimportant when the scale factor determination circuitry 240 selects a scale factor, since each associated target value t_{FP32} has the same sign and/or exponent as its corresponding weight value w_{FP32}. Therefore, reduction of information loss, reduction of bias, and/or reduction of truncation error as related to only the lower-order mantissa bits is performed by the scale factor determination circuitry 240.

Furthermore, in examples disclosed herein, when the value w of a single element, operand, and/or value is known by the scale factor determination circuitry 240 ahead of time and is always unchanged, then it is possible to find the optimal scale factor for it by enumerating all FP32 values (e.g., as discretely representable on a particular computing device) between 1.0 and 2.0. By enumerating such values, the scale factor determination circuitry 240 may select a scale factor with the least associated precision loss across all the weight values. That is, the scale factor s, in these examples, may be selected by the scale factor determination circuitry 240 when abs((w*S)_{FP32}−(w*s)_{BF16}) is reduced. In these examples, when the value of w is now known by the scale factor determination circuitry 240 ahead of time and/or is dynamic, the mantissa bits of the resulting value (e.g., after operation) is considered by the scale factor determination circuitry 240. For example, Equation 6 below shows two example FP32 values, represented below in their bit-wise format.

$$w = {( - 1 )}^{{b}_{31}^{w}} * {2}^{( {b}_{30}^{w} {b}_{29}^{w} … {b}_{23}^{w} ) - 127} * {( 1 \cdot {b}_{22}^{w} {b}_{21}^{w} … {b}_{0}^{w} )}_{2} \\ s = {( - 1 )}^{{b}_{31}^{s}} * {2}^{( {b}_{30}^{s} {b}_{29}^{s} … {b}_{23}^{s} ) - 127} * {( 1 \cdot {b}_{22}^{s} {b}_{21}^{s} … {b}_{0}^{s} )}_{2} \qquad Equation 6$$

When w and s from Equation 6 are multiplied together, considering the multiplication of values of mantissa bits (i.e.

$${( 1 \cdot {b}_{22}^{w} {b}_{21}^{w} … {b}_{0}^{w} )}_{2} and {( 1 \cdot {b}_{22}^{s} {b}_{21}^{s} … {b}_{0}^{s} )}_{2} ) ,$$

(when the result is less than 2) or 48 bits (when result is greater than or equals 2). In order to return to the original FP32 value representation format, the lowest-order 23 bits or 24 bits in the mantissa must be dropped. Furthermore, when casting the FP32 result into BF16 value representation format, the lowest-order 16 mantissa bits would be in need of further truncation (e.g., by the scale factor determination circuitry 240) in order to conform to the standards of the particular value representation format. That is, the value of the dropped mantissa bits (e.g., in integer form) is proportional to the precision loss experienced when casting the scaled FP32 value into BF16 format (e.g., by the scale factor determination circuitry 240), as shown in Equation 7 below. Therefore, when enumerating all FP32 values (e.g., as discretely representable on a particular computing device) between 1.0 and 2.0 when the input value(s) w is unknown, the scale factor determination circuitry 240 selects a scale factor with the least associated dropped value, and accordingly, the least associated precision loss.

$${Δ}_{dropped} = {y}_{i} \& ( 1 ≪ 39 ) = ( {( {b}_{cons𝔱 \_ 1} {b}_{22}^{w} {b}_{21}^{w} … {b}_{0}^{w} )}_{2} * {( {b}_{cons𝔱 \_ 1} {b}_{22}^{s} {b}_{22}^{s} … {b}_{0}^{s} )}_{2} ) \% {2}^{39} = ( {w}_{m} * {s}_{m} ) \% {2}^{39} \qquad Equation 7$$

In some examples, the example scale factor determination circuitry 240 is instantiated by processor circuitry executing scale factor determination circuitry 240 instructions and/or configured to perform operations such as those represented by the flowcharts of FIGS. 8, 9, 10, and/or 11.

In some examples, the scale factor determination circuitry 240 includes means for determining a scaling factor to be used in conversion and/or de-conversion of the high-precision data representation format (e.g., FP32) to the low-precision data representation format (e.g., BF16). For example, the means for determining a scaling factor to be used in conversion and/or de-conversion of the high-precision data representation format (e.g., FP32) to the low-precision data representation format (e.g., BF16) may be implemented by scale factor determination circuitry 240. In some examples, the scale factor determination circuitry 240 may be instantiated by processor circuitry such as the example processor circuitry 1212 of FIG. 12. For instance, the scale factor determination circuitry 240 may be instantiated by the example microprocessor 1300 of FIG. 13 executing machine executable instructions such as those implemented by at least blocks 804, 812, 906, 910, and/or 912 of FIGS. 8 and/or 9. In some examples, the scale factor determination circuitry 240 may be instantiated by hardware logic circuitry, which may be implemented by an ASIC, XPU, or the FPGA circuitry 1400 of FIG. 14 structured to perform operations corresponding to the machine readable instructions. Additionally or alternatively, the scale factor determination circuitry 240 may be instantiated by any other combination of hardware, software, and/or firmware. For example, the scale factor determination circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example model execution circuitry 250 applies the weight and/or scaling factor determined by the scale factor determination circuitry 250 and across all values utilized by the ML/AI model. In some examples, the example model execution circuitry 250 is instantiated by processor circuitry executing model execution circuitry 250 instructions and/or configured to perform operations such as those represented by the flowcharts of FIGS. 8, 9, 10, and/or 11.

In some examples, the model execution circuitry 250 includes means for applying the weight and/or scaling factor determined by the scale factor determination circuitry 250 and across all values utilized by the ML/AI model. For example, the means for applying the weight and/or scaling factor determined by the scale factor determination circuitry 250 and across all values utilized by the ML/AI model may be implemented by model execution circuitry 250. In some examples, the model execution circuitry 250 may be instantiated by processor circuitry such as the example processor circuitry 1212 of FIG. 12. For instance, the model execution circuitry 250 may be instantiated by the example microprocessor 1300 of FIG. 13 executing machine executable instructions such as those implemented by at least blocks 806-810 and/or 1106-1114 of FIGS. 8 and/or 11. In some examples, the model execution circuitry 250 may be instantiated by hardware logic circuitry, which may be implemented by an ASIC, XPU, or the FPGA circuitry 1400 of FIG. 14 structured to perform operations corresponding to the machine readable instructions. Additionally or alternatively, the model execution circuitry 250 may be instantiated by any other combination of hardware, software, and/or firmware. For example, the model execution circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example executable generation circuitry 260 outputs an executable file that an accelerator (e.g., GPU, FPGA, etc.) can execute and/or instantiate in order to perform an ML/AI workload. In some examples, the example executable generation circuitry 260 is instantiated by processor circuitry executing executable generation circuitry 260 instructions and/or configured to perform operations such as those represented by the flowcharts of FIGS. 8, 9, 10, and/or 11.

In some examples, the executable generation circuitry 260 includes means for outputting an executable file that an accelerator (e.g., GPU, FPGA, etc.) can execute and/or instantiate in order to perform an ML/AI workload. For example, the means for outputting an executable file that an accelerator (e.g., GPU, FPGA, etc.) can execute and/or instantiate in order to perform an ML/AI workload may be implemented by mode execution circuitry 260. In some examples, the model execution circuitry 260 may be instantiated by processor circuitry such as the example processor circuitry 1212 of FIG. 12. For instance, the model execution circuitry 260 may be instantiated by the example microprocessor 1300 of FIG. 13 executing machine executable instructions such as those implemented by at least blocks 816 and/or 914 of FIGS. 8 and/or 9. In some examples, the model execution circuitry 260 may be instantiated by hardware logic circuitry, which may be implemented by an ASIC, XPU, or the FPGA circuitry 1400 of FIG. 14 structured to perform operations corresponding to the machine readable instructions. Additionally or alternatively, the model execution circuitry 260 may be instantiated by any other combination of hardware, software, and/or firmware. For example, the model execution circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the illustrated example of FIG. 2, the interface circuitry 210, the data precision selection circuitry 220, the scale factor technique selection circuitry 230, the scale factor determination circuitry 240, the model execution circuitry 250, the executable generation circuitry 260, and the datastore 270, containing the machine-learning (ML) model(s) 272, the operator values 274, the scale factor 276, and the executable(s) 278 are in communication with one(s) of each other via the bus 280. For example, the bus 280 can be implemented by at least one of an Inter-Integrated Circuit (I2C) bus, a Serial Peripheral Interface (SPI) bus, a Peripheral Component Interconnect (PCI) bus, or a Peripheral Component Interconnect Express (PCIe or PCIE) bus. Additionally, or alternatively, the bus 280 can be implemented by any other type of computing or electrical bus.

In examples disclosed herein, the example datastore 270 may be any of type of data storage, database, etc. containing the example machine-learning (ML) model(s) 272 and the example operator values 274, as obtained by the interface circuitry 210, the example scale factors 276, as determined by the scale factor technique selection circuitry 230 and the scale factor determination circuitry 240, and the example executable(s) 278 as utilized and/or generated by the model execution circuitry 250 and the executable generation circuitry 260.

While an example manner of implementing the accelerator compiler 104A-C of FIG. 1 is illustrated in FIG. 2, one or more of the elements, processes, and/or devices illustrated in FIG. 2 may be combined, divided, re-arranged, omitted, eliminated, and/or implemented in any other way. Further, the example interface circuitry 210, the example data precision selection circuitry 220, the example scale factor technique selection circuitry 230, the example scale factor determination circuitry 240, the example model execution circuitry 250, the example executable generation circuitry 260, and/or, more generally, the example accelerator compiler 104A-C of FIG. 1, may be implemented by hardware alone or by hardware in combination with software and/or firmware. Thus, for example, any of the example interface circuitry 210, the example data precision selection circuitry 220, the example scale factor technique selection circuitry 230, the example scale factor determination circuitry 240, the example model execution circuitry 250, the example executable generation circuitry 260, and/or, more generally, the example accelerator compiler 104A-C of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example accelerator compiler 104A-C of FIG. 1 may include one or more elements, processes, and/or devices in addition to, or instead of, those illustrated in FIG. 2, and/or may include more than one of any or all of the illustrated elements, processes and devices.

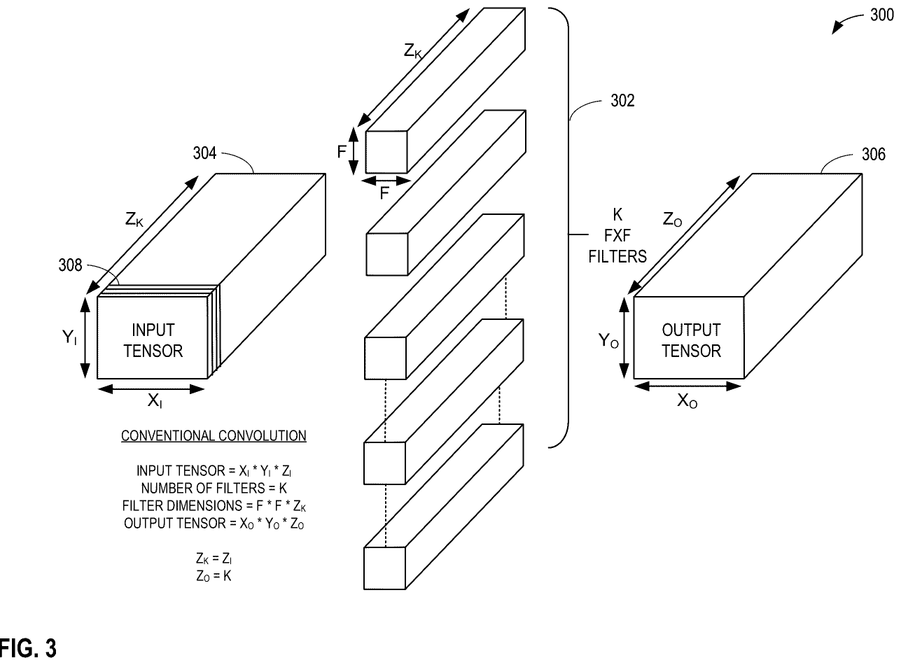

FIG. 3 is an illustration of an example conventional convolution operation 300 that may be executed by the first acceleration circuitry 108 of FIG. 1, the second acceleration circuitry 110 of FIG. 1, and/or the accelerator compiler 200 of FIG. 2. In some examples, the conventional convolution operation 300 may implement a spatial convolution over one or more images (e.g., a picture, a still frame of a video, etc.) and/or operations (e.g., dot product operations). In some examples, the accelerator compiler 300 may be configured to operate in a conventional convolution mode, a 2-D convolution mode, a three-dimensional (3-D) convolution mode, etc., based on the conventional convolution operation to be executed by the accelerator compiler 200.

The conventional convolution operation 300 includes applying example filters 302 to an example input tensor 304 to generate an example output tensor 306. In this example, the input tensor 304 is a 3-D object having a size of xᵢ*yᵢ*zᵢ. In this example, there are K of the filters 302 and each of the filters 402 have a size of f*f*zₖ. Alternatively, any other size may be used to implement one(s) of the filters 302. For example, one or more of the filters 402 may have a size of fₓ*f_{y}*zₖ where x and y may be different and thereby fₓ and f_{y} may be different. In this example, the filters 302 are square filters and thereby fₓ is equal to f_{y} but examples described herein are not so limited. In this example, the output tensor 306 has a size of xₒ*yₒ*zₒ. In this example, zₖ=zᵢ and zₒ=K. In this example, the filters 402 along with a non-linear activation function are applied to the input tensor 404 to produce the output tensor 306. For example, the accelerator compiler 200 of FIG. 2 may obtain the input tensor 304 as the activation data, obtain one of the filters 302 as the weight data, and output the output tensor 306. In some such examples, the accelerator compiler 200 may implement the conventional convolution operation 300 in a “dense” manner while, in other examples, the accelerator compiler 200 may implement the conventional convolution operation 300 utilizing sparsity.

Advantageously, the accelerator compiler 300 may execute the convolution operation 300 based on sparse data to reduce the number of computations. For example, the accelerator compiler 200 may obtain and/or generate activation sparsity data and/or weight sparsity data to output the output tensor 306 by invoking sparsity techniques.

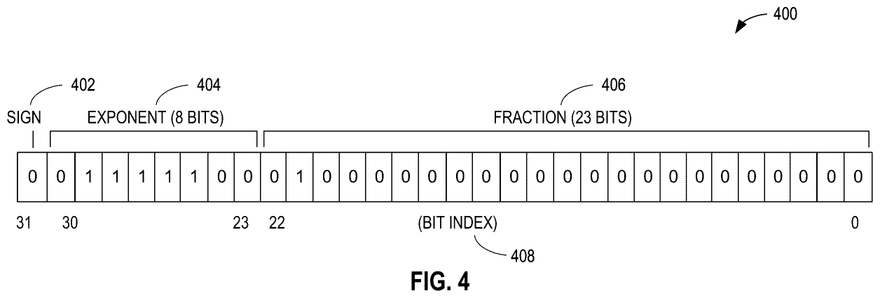

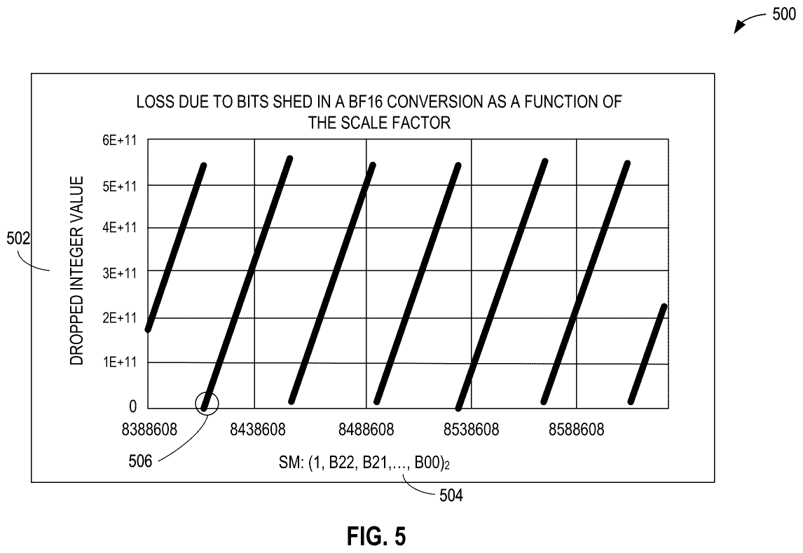

FIG. 4 illustrates a bit-wise binary representation 400 of an example FP32 value. In the illustrated bit-wise binary representation 400, 1 sign bit 402, 8 exponent bits 404, and 23 fraction (mantissa) bits 406 are shown, along with their corresponding bit index 408. In this illustrated example, the leftmost bits (e.g., sign bit 402, exponent bits 404), as are enumerated as higher values according to the bit index 408 are not considered by the scale factor technique selection circuitry 230 and/or the scale factor determination circuitry 240 when scaled, as explained in greater detail herein. The lowest order bits, as represented by the lower values enumerated by the bit index 408 (e.g., mantissa bits 406) masked and/or truncated by the scale factor technique selection circuitry 230 and/or the scale factor determination circuitry 240 when scaling between data representation formats is performed. FIG. 5 illustrates an example enumeration process of selection for a scale factor, as performed by the example scale factor determination circuitry 240 of FIG. 2. As explained in conjunction with FIG. 2, the input value of a single element, operand, and/or value is known by the example scale factor determination circuitry 240 of FIG. 2 prior to training and/or inference and is always unchanged, then it is possible to find the optimal scale factor for the value(s) by enumerating all FP32 values (e.g., as discretely representable on a particular computing device) between 1.0 and 2.0. By enumerating such values, the scale factor determination circuitry 240 of FIG. 2 may select a scale factor with the least associated precision loss. The illustrated example of FIG. 5 depicts a scale factor enumeration graph 500 in which a dropped integer value 502 is plotted against an enumerated scale factor 504. In examples disclosed herein, the dropped integer value 502 represents the value dropped from the value in conversion to a less-precise data representation format (e.g., in integer form) and is proportional to the loss of precision when converting between data representation formats. The scale factor enumeration graph 500 is a periodic variation graph for an arbitrary input value (e.g., 1.66666667), showing a trend of dropped integer values 502, as the enumerated scale factor 504 changes. The minimum drop variation point 506, as shown in the illustrated example of FIG. 5 represents a point of minimum observed dropped interview value 502 loss, and thus, accordingly, the minimum drop variation point 506 further represents the point of least precision loss. Thus, the enumerated scale factor 504 of the x-axis at that coordinate would be selected by the scale factor determination circuitry 240 of FIG. 2 as the scale factor to apply to the ML/AI model values.

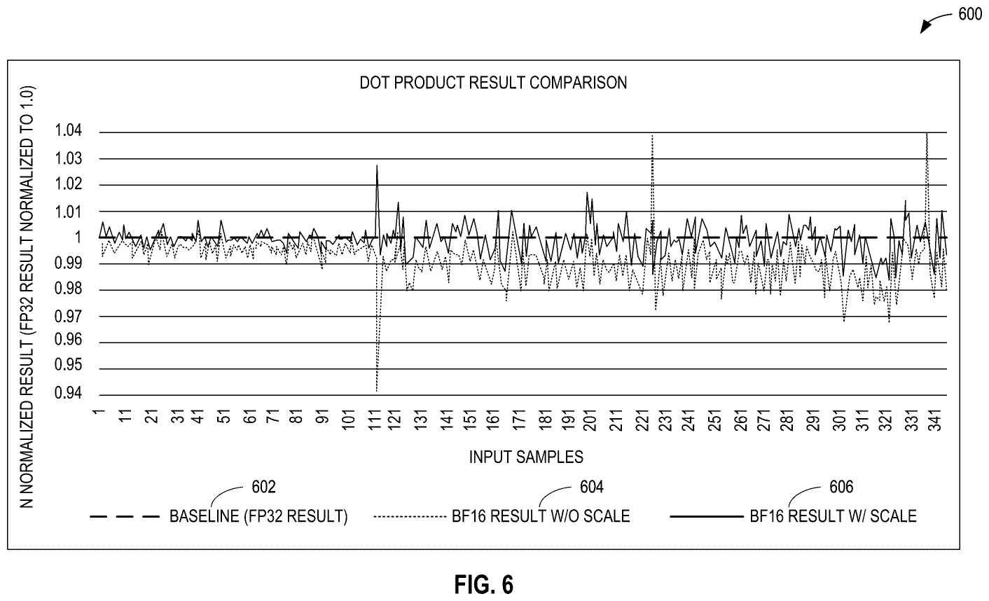

FIG. 6 shows an example comparative accuracy graph 600 for example dot product operations using baseline FP32 values 602, converted BF16 values 604, and scaled BF16 values 606. As depicted in the comparative accuracy graph 600, dot product operations performed using the scaled BF16 values 606 present the most variation in accuracy, as compared to that afforded by the baseline FP32 values 602. The comparative accuracy graph 600 further shows the accuracy results in relation to the scaled BF16 values 606 as more closely following the baseline FP32 values, as opposed to the converted BF16 values 604, indicating a higher level of accuracy achieved by using the scaling techniques described herein when using lower-precision data representation formats to increase efficiency of computation and/or reduce resource expenditure.

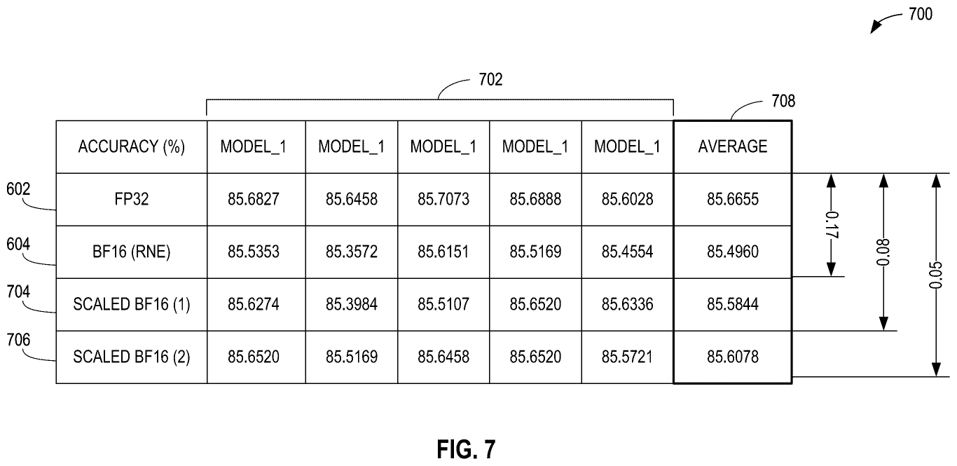

FIG. 7 illustrates an example accuracy percent table 700, across a set of tested machine-learning (ML) and/or artificial intelligence (AI) models 702 for example operations (e.g., dot product operations) using baseline FP32 values 602 (of FIG. 6), converted BF16 values 604 (of FIG. 6), a first technique of scaled BF16 values 704, and a second technique of scaled BF16 values 706. As described in greater detail in conjunction with FIG. 2, the first technique of scaled BF16 values 704 correspond to BF16 values that are scaled by the scale factor technique selection circuitry 230 and/or the scale factor determination circuitry 240 of FIG. 2 when the input values (w) are known. Similarly, the second technique of scaled BF16 values 706 correspond to BF16 values that are scaled by the scale factor technique selection circuitry 230 and/or the scale factor determination circuitry 240 of FIG. 2 when the input values (w) are known. The rightmost column of the accuracy percent table 700 shows an average accuracy 708 afforded across all tested ML/AI models 702. The average accuracy 708 associated with the baseline FP32 values 602 represents an ideal accuracy value across the tested ML/AI models 702. Both the first technique of scaled BF16 values 704 and the second technique of scaled BF16 values 706 show an associated average accuracy 708 that are greater than that of the converted BF16 values 604 (e.g., are closest to the average accuracy 708 of the baseline FP32 values 602), further indicating a high accuracy of operation achieved even through use of the lower-precision data representation format (e.g., BF16), by way of the scaling process (e.g., both the first technique of scaling and/or the second technique of scaling).

Flowcharts representative of example machine readable instructions, which may be executed to configure processor circuitry to implement the accelerator compiler 200 of FIG. 2, are shown in FIGS. 8-11. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 14. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 8-11, many other methods of implementing the example accelerator compiler 200 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8-11 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed and/or instantiated by processor circuitry to perform scale shifting of lower-precision data representation formatted-values in order to achieve higher accuracy and/or efficiency of computation. The machine readable instructions and/or the operations 800 of FIG. 8 begin at block 802, at which data precision selection circuitry 220 identifies a first precision data type and a second precision data type associated with execution of a machine-learning (ML) model by acceleration hardware (e.g., accelerator compiler 200). As explained herein, the types of data representation formats employed by the accelerator compiler 200 may vary based on hardware and/or execution constraints. In examples disclosed herein, FP32 and BF16 data representation formats are described, with the former being the high-precision data representation format, and the latter being the low-precision data representation format. However, in other examples, any other types of data types of a high-precision and low-precision level may be identified by the scale factor determination circuitry 240 at block 802.

At block 804, the model execution circuitry 250 determines scale factors to be applied to first weights with the first precision data type of the machine-learning (ML) model. The first precision data type, in examples disclosed herein, may be either the high-precision data type or the low-precision data type, depending on the application. The first weight determined by the model execution circuitry 250 is the target value, as described in conjunction with FIG. 2. In examples disclosed herein, the target value is calculated and/or determined by the model execution circuitry 250 of FIG. 2 when the input values (w) are known prior to execution of the ML model.

At block 806, the model execution circuitry 250 converts the first weights to second weights with the second precision data type based on a multiplication of the first weights and the scale factor(s). As described in greater detail herein (in conjunction with FIG. 2), the second weights may be calculated (e.g., by the scale factor determination circuitry 240 and/or the model execution circuitry 250) by enumerating across all possible scale factors and determining the scale factor that yields the lowest loss of precision during multiplication of values.

At block 808, the model execution circuitry 250 executes the machine-learning (ML) model based on the second weight(s). In examples disclosed herein, the same weight may be calculated and/or applied across all values utilized by the ML model, however, in other examples, a plurality of weights may be calculated and/or applied, based on a particular loss of precision afforded by each value.

At block 810, the scale factor technique selection circuitry 230 determines whether an accuracy of the machine-learning (ML) model improved beyond a threshold value. If the scale factor technique selection circuitry 230 determines that the accuracy of the ML model did improve beyond a threshold value, the process moves to block 812. However, if the scale factor technique selection circuitry 230 determines that the accuracy of the ML model did not improve beyond a threshold value, the process moves forward to block 814.

At block 812, the scale factor determination circuitry 240, in response to a determination by the scale factor technique selection circuitry 230 at block 810 that an accuracy of the ML model improved beyond a threshold value, adjusts the scale factor(s) to achieve an even greater level of accuracy. As described in conjunction with FIG. 2, the scale factor determination circuitry 240 adjusts the scale factor(s) by enumerating across all scaling values to determine the next best value that lends the lowest loss of precision.

At block 814, the scale factor technique selection circuitry 230, in response to a determination by the scale factor technique selection circuitry 230 that an accuracy of the ML model did not improve beyond a threshold, value at block 810, selects another technique to determine the scale factor(s). An example first technique may involve enumeration of all possible scale factors, with a selection of the factor that best reduces precision loss by the scale factor technique selection circuitry 230, for example. If the scale factor technique selection circuitry 230 determines that another technique is to be selected to determine the scale factor(s), the process moves back to block 804. However, if the scale factor technique selection circuitry 230 determines that another technique is not to be selected, the process moves forward to block 816.

At block 816, the executable generation circuitry 260 outputs an executable based on the machine-learning (ML) model, the scale factor(s), and the second weights. In examples disclosed herein, this executable may represent an optimal set of weights and/or scale factor(s) used to achieve an improved computing performance with reduced resource expenditure and high accuracy of operation.

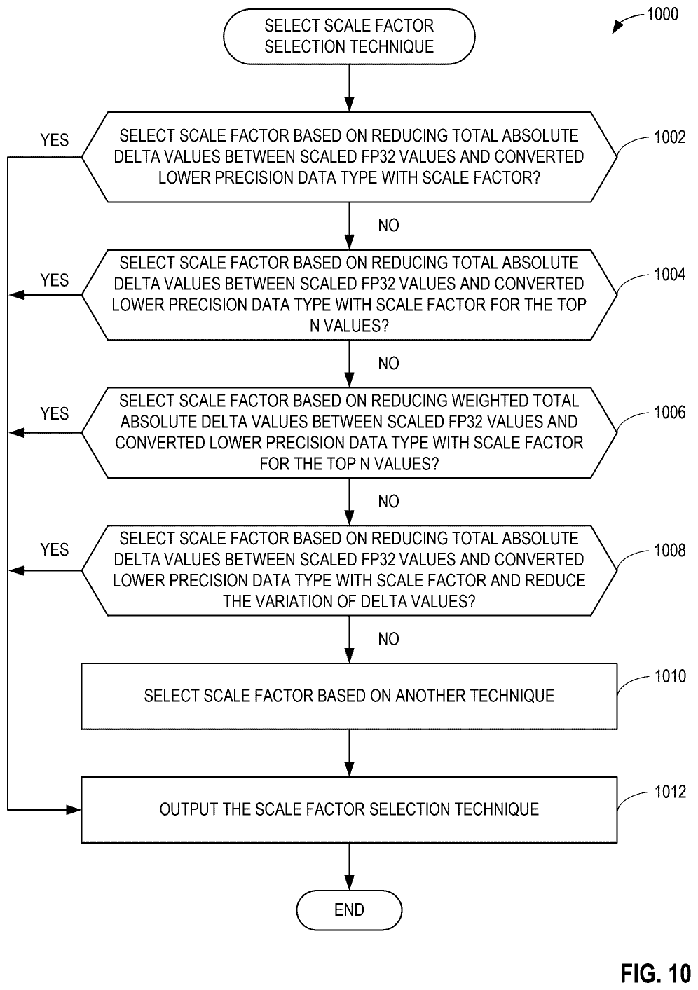

FIG. 9 is a flowchart representative of example machine readable instructions and/or example operations 900 that may be executed and/or instantiated by processor circuitry to perform per-tensor scale shifting for all values involved in operations of an ML/AI model. The machine readable instructions and/or the operations 900 of FIG. 9 begin at block 902, at which the scale factor technique selection circuitry 230 selects a scale factor selection technique. The process of selecting a scale factor selection technique by the scale factor technique selection circuitry 230 is described further in conjunction with FIG. 10.

At block 904, the scale factor technique selection circuitry 230 determines whether the scale factor selection technique is based on a scale factor per tensor, as may be indicated, in examples disclosed herein, by example data stored in a datastore associated with scale factor(s) etc. (e.g., datastore 270 of FIG. 2). If the scale factor technique selection circuitry 230 determines that the scale factor selection technique is based on a scale factor per tensor, the process moves to block 906. However, if the scale factor technique selection circuitry 230 determines that the scale factor selection technique is not based on a scale factor per tensor, the process moves forward to block 908.

At block 906, the scale factor determination circuitry 240 determines a scale factor to be utilized per tensor. In examples disclosed herein, the scale factor determination circuitry 240 may make this determination based on hardware constraints of a particular tensor, associated available data representation formats, etc.

At block 908, the scale factor technique selection circuitry 230, having determined at block 90 that the scale factor selection technique is not based on a scale factor per tensor, determines whether the scale factor selection technique is based on a scale factor per channel. If the scale factor technique selection circuitry 230 determines that the scale factor selection technique is based on a scale factor per channel, the process moves to block 910. However, if the scale factor technique selection circuitry 230 determines that the scale factor selection technique is not based on a scale factor per channel, the process moves forward to block 912.

At block 910, the scale factor determination circuitry 240 determines a scale factor to be utilized per channel. Similar to the determination made by the scale factor determination circuitry 240 at block 906, the scale factor(s) across all tensors within a particular channel may be aggregated, averaged, etc. to determine a singular scale factor to be utilized per channel.

At block 912, the scale factor determination circuitry 240 outputs the scale factor(s) to be utilized for execution of the machine-learning (ML) model. In examples disclosed herein, the scale factor(s) may be stored in an example database (e.g., datastore 270 of FIG. 2).

At block 914, the executable generation circuitry 260 outputs an executable based on the machine-learning (ML) model and the scale factor(s). In examples disclosed herein, both the ML model and scale factor(s) may be stored in the example datastore 270 of FIG. 2. The executable, in example disclosed herein, may be specific to the hardware constrains specified with the particular ML model, but in some examples, it may be generalized across various types of ML models.

FIG. 10 is a flowchart representative of example machine readable instructions and/or example operations 1000 that may be executed and/or instantiated by processor circuitry to select a scale factor selection technique to employ in order to determine a scaling factor for all values used for operations by an ML/AI model. The machine readable instructions and/or the operations 1000 of FIG. 10 begin at block 1002, at which the scale factor technique selection circuitry 230 determines whether a scale factor based on reducing total absolute delta values between scaled FP32 values and converted lower precision data types with a scale factor is the scale factor technique selection of choice. In examples disclosed herein, the scale factor technique selection circuitry 230 may determine any particular scale factor technique selection of choice based on pre-specified hardware constraints afforded for a particular ML model, a particular workload domain, a type of data representation formats afforded by a particular ML model and/or set of operands, etc.

At block 1004, the scale factor technique selection circuitry 230 determines whether the scale factor is to be selected based on reducing total absolute delta values between scale FP32 values and converted lower precision data type values with a scale factor for the top n values. In examples disclosed herein, the top n values may represent a square root of a number of total dimension of a set of values, indicating a sampling algorithm of n values to which a scale factor is applied.

At block 1006, the scale factor technique selection circuitry 230 determines whether the scale factor to be selected is based on minimizing a weighted total absolute set of delta values between the scaled FP32 values and the converted lower precision data type with the scale factor for the top n values. Similarly to the determination made by the scale factor technique selection circuitry 230 at block 1004, the scale factor technique selection circuitry 230 determines, at block 1006, whether weighted total absolute delta values are reduced. In examples disclosed herein, the weighted total absolute delta values represent a higher level accuracy that may be achieved by assigning logarithmically smaller weights in descending order. For the bottom half of values (between top n/2 and top n) the weight is 1, for half of the values above them (between top n/4 and top n/2) the weight is 2, and so on. Thus the weight for a top 1 value is (1+log2 n), which therefore is a technique that biases the accuracy higher without overfitting the scale.

At block 1008, the scale factor technique selection circuitry 230 determines whether the scale factor is to be selected based on minimizing total absolute delta values between the scaled FP32 values and the converted lower precision data type values with the scale factor to reduce the variation of delta values, representing yet another variation affording a greater level of accuracy.

At block 1010, the scale factor technique selection circuitry 230 selects a scale factor based on another technique, different from those of blocks 1002-1008.

At block 1012, the scale factor technique selection circuitry 230 outputs the scale factor selection technique of choice.

FIG. 11 is a flowchart representative of example machine readable instructions and/or example operations 1100 that may be executed and/or instantiated by processor circuitry to perform de-scaling of lower-precision values once an operation executed by an ML/AI model is completed. The machine readable instructions and/or the operations 1100 of FIG. 11 begin at block 1102, at which the interface circuitry 210 obtains a (set of) operator(s) to execute a machine-learning operation. In examples disclosed herein, the operators may be stored in a database (e.g., datastore 270 of FIG. 2) or provided along with a particular ML model and/or operation of choice.

At block 1104, the data precision selection circuitry 220 determines whether the operators are based on a lower precision data type. In examples disclosed herein, some operators, provided via a database (e.g., datastore 270 of FIG. 2), etc. may not be in need of further scaling to a lower precision data type if already provided as a low precision data type and/or unable to be further scaled down. Therefore, if the model execution circuitry 250 determines that the operators are based on a lower precision data type, the process moves to block 1106. However, if the model execution circuitry 250 determines that the operators are not based on a lower precision data type, the process moves forward to block 1108.

At block 1106, the model execution circuitry 250 scales the operators using scale factor(s). In examples disclosed herein, the scale factor(s) may be provided as weighted to be imputed across an ML model and/or multiplied to each of the operator values.

At block 1108, the model execution circuitry 250 determines the output values of the machine-learning (ML) operation based on the scaled operators. In examples disclosed herein, these output values may be the result of the operation performed on the scaled operators.

At block 1110, the model execution circuitry 250 descales the output values determined by the model execution circuitry 250 at block 1108. In examples disclosed herein, de-scaling is performed by, for example, dividing (e.g., multiplying the inverse of) the output values by the same scaling factor that was multiplied onto it during scaling, thus effectively reversing the scaling process.

At block 1112, the model execution circuitry 250 outputs the de-scaled output values to another logical entity. In examples disclosed herein, the logical entit(ies) may be, for example, the external computing devices 130 of FIG. 1, or any other type of computing device and/or logical entity.

At block 1114, the model execution circuitry 250 determines whether another machine-learning (ML) operation is to be performed (e.g., using the same and/or different operators). If the model execution circuitry 250 determines that another ML operation is to be performed, the process returns back to block 1102. However, if the model execution circuitry 250 determines that another ML operation is not to be performed, the process ends.

FIG. 12 is a block diagram of an example processor platform 1200 structured to execute and/or instantiate the machine readable instructions and/or the operations of FIGS. 8-11 to implement the accelerator compiler 200 of FIG. 2. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example interface circuitry 210, the example data precision selection circuitry 220, the example scale factor technique selection circuitry 230, the example scale factor determination circuitry 240, the example model execution circuitry 250, and/or the example executable generation circuitry 260.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 422 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIGS. 8-11, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 8-11 to effectively instantiate the circuitry of FIG. 2 [er diagram] as logic circuits to perform the operations corresponding to those machine readable instructions. In some such examples, the accelerator compiler 200 of FIG. 2 is instantiated by the hardware circuits of the microprocessor 1300 in combination with the instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIG. 8-11.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally, or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowcharts of FIGS. 8-11 but whose interconnections and logic circuitry are fixed once fabricated), the FPGA circuitry 1400 of the example of FIG. 14 includes interconnections and logic circuitry that may be configured and/or interconnected in different ways after fabrication to instantiate, for example, some or all of the machine readable instructions represented by the flowcharts of FIGS. 8-11. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowcharts of FIGS. 8-11. As such, the FPGA circuitry 1400 may be structured to effectively instantiate some or all of the machine readable instructions of the flowcharts of FIGS. 8-11 as dedicated logic circuits to perform the operations corresponding to those software instructions in a dedicated manner analogous to an ASIC. Therefore, the FPGA circuitry 1400 may perform the operations corresponding to the some or all of the machine readable instructions of FIGS. 8-11 faster than the general purpose microprocessor can execute the same.

In the example of FIG. 14, the FPGA circuitry 1400 is structured to be programmed (and/or reprogrammed one or more times) by an end user by a hardware description language (HDL) such as Verilog. The FPGA circuitry 1400 of FIG. 14, includes example input/output (I/O) circuitry 1402 to obtain and/or output data to/from example configuration circuitry 1404 and/or external hardware 1406. For example, the configuration circuitry 1404 may be implemented by interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may be implemented by external hardware circuitry. For example, the external hardware 1406 may be implemented by the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations that may correspond to at least some of the machine readable instructions of FIGS. 8-11 and/or other desired operations. The logic gate circuitry 1408 shown in FIG. 14 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 108 to facilitate access and increase execution speed.

The example FPGA circuitry 1400 of FIG. 14 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 14 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 6. Therefore, the processor circuitry 1212 of FIG. 12 may additionally be implemented by combining the example microprocessor 1300 of FIG. 13 and the example FPGA circuitry 1400 of FIG. 14. In some such hybrid examples, a first portion of the machine readable instructions represented by the flowcharts of FIGS. 8-11 may be executed by one or more of the cores 1302 of FIG. 13, a second portion of the machine readable instructions represented by the flowcharts of FIGS. 8-11 may be executed by the FPGA circuitry 1400 of FIG. 14, and/or a third portion of the machine readable instructions represented by the flowcharts of FIGS. 8-11 may be executed by an ASIC. It should be understood that some or all of the accelerator compiler 200 of FIG. 2 may, thus, be instantiated at the same or different times. Some or all of the circuitry may be instantiated, for example, in one or more threads executing concurrently and/or in series. Moreover, in some examples, some or all of the accelerator compiler 200 of FIG. 2 may be implemented within one or more virtual machines and/or containers executing on the microprocessor.

In some examples, the processor circuitry 1212 of FIG. 12 may be in one or more packages. For example, the microprocessor 1300 of FIG. 13 and/or the FPGA circuitry 1400 of FIG. 14 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

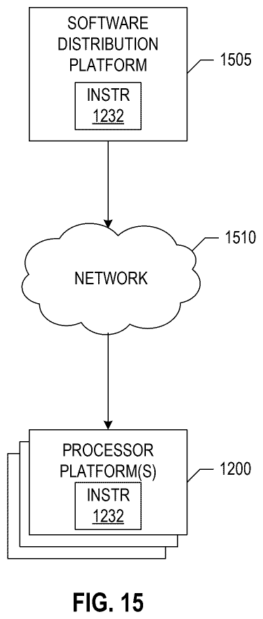

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions 800, 900, 1000, and/or 1100 of FIGS. 8-11, as described above. The one or more servers of the example software distribution platform 1505 are in communication with an example network 1510, which may correspond to any one or more of the Internet and/or any of the example networks 128, 1226, 1510 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions 800, 900, 1000, and/or 1100 of FIGS. 8-11, may be downloaded to the example processor platform 400, which is to execute the machine readable instructions 1232 to implement the accelerator compiler 200 of FIG. 2. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

Certain examples provide an apparatus for performing scale shifting on lower precision values to facilitate efficient and high-accuracy performance including a means for identifying a first precision data type and a second precision data type associated with execution of a machine-learning odel by acceleration hardware, the first precision data type to have a first data precision greater than a second data precision of the second precision data type. The means for identifying can be implemented by the accelerator compiler 200 of FIG. 2 and/or, more specifically, the data precision selection circuitry 220 of FIG. 2, for example. The example apparatus also includes a means for determining at least one scale factor to be applied to first weights of the machine-learning model, the first weights based on the first precision data type. The means for determining can be implemented by the accelerator compiler 200 of FIG. 2 and/or, more specifically, the scale factor determination circuitry 240 of FIG. 2, for example. The example apparatus also includes a means for converting the first weights to second weights based on a multiplication of the first weights and the at least one scale factor, the second weights based on the second precision data type. The means for converting can be implemented by the accelerator compiler 200 of FIG. 2 and/or, more specifically, the scale factor determination circuitry 240 of FIG. 2, for example. The example apparatus also includes a means for generating an output from execution of the machine-learning model based on the second weights. The means for generating can be implemented by the accelerator compiler 200 of FIG. 2 and/or, more specifically, the model execution circuitry 250 and the executable generation circuitry 260 of FIG. 2, for example.

From the foregoing, it will be appreciated that example systems, methods, apparatus, and articles of manufacture have been disclosed that perform scale-shifting of lower precision-formatted data representation types in order to afford higher accuracy computation of machine-learning (ML) and/or artificial intelligence (AI) models, while increasing computational efficiency and/or reducing resource expenditure. Disclosed systems, methods, apparatus, and articles of manufacture improve the efficiency of using a computing device by removing a loss-of-accuracy concern as a barrier to use of lower-precision data representation formats such as BF16 enables a massive reduction in computational cost, effort, and/or resource expenditure (e.g., through reduction of an overall memory footprint). Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for improving accuracy of operations by compensation for lower precision with scale shifting are disclosed herein. Further examples and combinations thereof include the following:

Example 1 includes a computer readable medium comprising instructions that, when executed, cause a machine to at least identify a first precision data type and a second precision data type associated with execution of a machine-learning model, the first precision data type to have a first data precision greater than a second data precision of the second precision data type, determine at least one scale factor to be applied to first weights of the machine-learning model, the first weights based on the first precision data type, convert the first weights to second weights based on a multiplication of the first weights and the at least one scale factor, the second weights based on the second precision data type, and generate an output from execution of the machine-learning model based on the second weights.

Example 2 includes the computer readable medium of example 1, wherein the first precision data type is based on single-precision floating-point format and the second precision data type is based on brain floating-point format.

Example 3 includes the computer readable medium of example 1, wherein the first precision data type is based on single-precision floating-point format and the second precision data type is based on half-precision floating-point format.

Example 4 includes the computer readable medium of example 1, further comprising instructions, when executed, further cause the machine to generate a target weight for a weight of the first weights based on a mask of one or more least significant bits of the weight being zero, and determine the at least one scale factor based on a ratio of the target weight and the weight of the first weights.

Example 5 includes the computer readable medium of example 1, wherein the at least one scale factor includes a first scale factor and a second scale factor, the first scale factor is associated with a first channel of a tensor of the machine-learning model, the second scale factor is associated with a second channel of the tensor, and the first scale factor is different from the second scale factor.

Example 6 includes the computer readable medium of example 1, wherein the at least one scale factor includes a first scale factor and a second scale factor, the first scale factor is associated with a first tensor of the machine-learning model, the second scale factor is associated with a second tensor of the machine-learning model, and the first scale factor is different from the second scale factor.

Example 7 includes the computer readable medium of any preceding example, wherein the instructions, when executed, cause the machine to determine the at least one scale factor during execution of the machine-learning model.

Example 8 includes the computer readable medium of example 1, wherein the output generated from execution of the machine-learning model based on the second weights includes the at least one scale factor for use in de-scaling.

Example 9 includes the computer readable medium of example 8, wherein the instructions, when executed, cause the machine to perform de-scaling by dividing the output from execution of the machine-learning model by the second weights.

Example 10 includes an apparatus to perform scale shifting on lower precision values to facilitate efficient and high-accuracy performance comprising interface circuitry to obtain a machine-learning model, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate data precision selection circuitry to identify a first precision data type and a second precision data type associated with execution of the machine-learning model by acceleration hardware, the first precision data type to have a first data precision greater than a second data precision of the second precision data type, scale factor determination circuitry to determine at least one scale factor to be applied to first weights of the machine-learning model, the first weights based on the first precision data type, and convert the first weights to second weights based on a multiplication of the first weights and the at least one scale factor, the second weights based on the second precision data type, and model execution circuitry to generate an output from execution of the machine-learning model based on the second weights.

Example 11 includes the apparatus of example 10, wherein the first precision data type is based on single-precision floating-point format and the second precision data type is based on brain floating-point format.

Example 12 includes the apparatus of example 10, wherein the first precision data type is based on single-precision floating-point format and the second precision data type is based on half-precision floating-point format.

Example 13 includes the apparatus of example 10, wherein scale factor determination circuitry is to further generate a target weight for a weight of the first weights based on a masking of one or more least significant bits of the weight being zero, and determine the at least one scale factor based on a ratio of the target weight and the weight of the first weights.

Example 14 includes the apparatus of example 10, wherein the at least one scale factor includes a first scale factor and a second scale factor, the first scale factor is associated with a first channel of a tensor of the machine-learning model, the second scale factor is associated with a second channel of the tensor, and the first scale factor is different from the second scale factor.

Example 15 includes the apparatus of any preceding example, wherein the at least one scale factor includes a first scale factor and a second scale factor, the first scale factor is associated with a first tensor of the machine-learning model, the second scale factor is associated with a second tensor of the machine-learning model, and the first scale factor is different from the second scale factor.

Example 16 includes the apparatus of example 10, wherein the output generated from execution of the machine-learning model based on the second weights by the model execution circuitry includes the at least one scale factor for use in de-scaling.

Example 17 includes the apparatus of example 16, wherein the model execution circuitry is to perform de-scaling by dividing the output from execution of the machine-learning model by the second weights.

Example 18 includes a method to perform scale shifting on lower precision values to facilitate efficient and high-accuracy performance comprising identifying a first precision data type and a second precision data type associated with execution of a machine-learning model by acceleration hardware, the first precision data type to have a first data precision greater than a second data precision of the second precision data type, determining, by executing an instruction with at least one processor, at least one scale factor to be applied to first weights of the machine-learning model, the first weights based on the first precision data type, converting the first weights to second weights based on a multiplication of the first weights and the at least one scale factor, the second weights based on the second precision data type, and generating an output from execution of the machine-learning model based on the second weights.

Example 19 includes the method of example 18, further comprising generating a target weight for a weight of the first weights based on a masking of one or more least significant bits of the weight being zero, and determining the at least one scale factor based on a ratio of the target weight and the weight of the first weights.

Example 20 includes the method of any preceding example, wherein the at least one scale factor includes a first scale factor and a second scale factor, the first scale factor is associated with a first channel of a tensor of the machine-learning model, the second scale factor is associated with a second channel of the tensor, and the first scale factor is different from the second scale factor.

Example 21 includes the method of example 18, wherein the output generated from execution of the machine-learning model based on the second weights includes the at least one scale factor for use in de-scaling.

Example 22 includes the method of example 21, wherein de-scaling is performed by dividing the output from execution of the machine-learning model by the second weights.

Example 23 includes an apparatus for performing scale shifting on lower precision values to facilitate efficient and high-accuracy performance, the apparatus comprising means for identifying a first precision data type and a second precision data type associated with execution of a machine-learning model by acceleration hardware, the first precision data type to have a first data precision greater than a second data precision of the second precision data type, means for determining at least one scale factor to be applied to first weights of the machine-learning model, the first weights based on the first precision data type, means for converting the first weights to second weights based on a multiplication of the first weights and the at least one scale factor, the second weights based on the second precision data type, and means for generating an output from execution of the machine-learning model based on the second weights.

Example 24 includes the apparatus of example 23, further comprising means for generating a target weight for a weight of the first weights based on a mask of one or more least significant bits of the weight being zero, and means for determining the at least one scale factor based on a ratio of the target weight and the weight of the first weights.

Example 25 includes an apparatus comprising means to perform any method of examples 18-22.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. A non-transitory computer readable medium comprising instructions that, when executed, cause a machine to at least:
identify a first precision data type and a second precision data type associated with execution of a machine-learning model, the first precision data type to have a first data precision greater than a second data precision of the second precision data type;
determine at least one scale factor to be applied to first weights of the machine-learning model, the first weights based on the first precision data type;
convert the first weights to second weights based on a multiplication of the first weights and the at least one scale factor, the second weights based on the second precision data type; and
generate an output from execution of the machine-learning model based on the second weights.

2. The non-transitory computer readable medium of claim 1, wherein the first precision data type is based on single-precision floating-point format and the second precision data type is based on brain floating-point format.

3. The non-transitory computer readable medium of claim 1, wherein the first precision data type is based on single-precision floating-point format and the second precision data type is based on half-precision floating-point format.

4. The non-transitory computer readable medium of claim 1, further comprising instructions, when executed, further cause the machine to:
generate a target weight for a weight of the first weights based on a mask of one or more least significant bits of the weight being zero; and
determine the at least one scale factor based on a ratio of the target weight and the weight of the first weights.

5. The non-transitory computer readable medium of claim 1, wherein the at least one scale factor includes a first scale factor and a second scale factor, the first scale factor is associated with a first channel of a tensor of the machine-learning model, the second scale factor is associated with a second channel of the tensor, and the first scale factor is different from the second scale factor.

6. The non-transitory computer readable medium of claim 1, wherein the at least one scale factor includes a first scale factor and a second scale factor, the first scale factor is associated with a first tensor of the machine-learning model, the second scale factor is associated with a second tensor of the machine-learning model, and the first scale factor is different from the second scale factor.

7. The non-transitory computer readable medium of claim 1, wherein the instructions, when executed, cause the machine to determine the at least one scale factor during execution of the machine-learning model.

8. The non-transitory computer readable medium of claim 1, wherein the output generated from execution of the machine-learning model based on the second weights includes the at least one scale factor for use in de-scaling.

9. The non-transitory computer readable medium of claim 8, wherein the instructions, when executed, cause the machine to perform de-scaling by dividing the output from execution of the machine-learning model by the second weights.

10. An apparatus to perform scale shifting on lower precision values to facilitate efficient and high-accuracy performance, the apparatus comprising:
interface circuitry to obtain a machine-learning model;
machine readable instructions; and
processor circuitry
to at least one of instantiate or execute the machine readable instructions to:
identify a first precision data type and a second precision data type associated with execution of the machine-learning model by acceleration hardware, the first precision data type to have a first data precision greater than a second data precision of the second precision data type;
determine at least one scale factor to be applied to first weights of the machine-learning model, the first weights based on the first precision data type;
convert the first weights to second weights based on a multiplication of the first weights and the at least one scale factor, the second weights based on the second precision data type; and
generate an output from execution of the machine-learning model based on the second weights.

11. The apparatus of claim 10, wherein the first precision data type is based on single-precision floating-point format and the second precision data type is based on brain floating-point format.

12. The apparatus of claim 10, wherein the first precision data type is based on single-precision floating-point format and the second precision data type is based on half-precision floating-point format.

13. The apparatus of claim 10, wherein scale factor determination circuitry is to further:
generate a target weight for a weight of the first weights based on a masking of one or more least significant bits of the weight being zero; and
determine the at least one scale factor based on a ratio of the target weight and the weight of the first weights.

14. The apparatus of claim 10, wherein the at least one scale factor includes a first scale factor and a second scale factor, the first scale factor is associated with a first channel of a tensor of the machine-learning model, the second scale factor is associated with a second channel of the tensor, and the first scale factor is different from the second scale factor.

15. The apparatus of claim 10, wherein the at least one scale factor includes a first scale factor and a second scale factor, the first scale factor is associated with a first tensor of the machine-learning model, the second scale factor is associated with a second tensor of the machine-learning model, and the first scale factor is different from the second scale factor.

16. The apparatus of claim 10, wherein the output generated from execution of the machine-learning model based on the second weights by the processor circuitry includes the at least one scale factor for use in de-scaling.

17. The apparatus of claim 16, wherein the processor circuitry is to perform de-scaling by dividing the output from execution of the machine-learning model by the second weights.

18. A method to perform scale shifting on lower precision values to facilitate efficient and high-accuracy performance, the method comprising:
identifying a first precision data type and a second precision data type associated with execution of a machine-learning model by acceleration hardware, the first precision data type to have a first data precision greater than a second data precision of the second precision data type;
determining, by executing an instruction with at least one processor, at least one scale factor to be applied to first weights of the machine-learning model, the first weights based on the first precision data type;
converting the first weights to second weights based on a multiplication of the first weights and the at least one scale factor, the second weights based on the second precision data type; and
generating an output from execution of the machine-learning model based on the second weights.

19. The method of claim 18, further comprising:
generating a target weight for a weight of the first weights based on a masking of one or more least significant bits of the weight being zero; and
determining the at least one scale factor based on a ratio of the target weight and the weight of the first weights.

20. The method of claim 18, wherein the at least one scale factor includes a first scale factor and a second scale factor, the first scale factor is associated with a first channel of a tensor of the machine-learning model, the second scale factor is associated with a second channel of the tensor, and the first scale factor is different from the second scale factor.

21.-25. (canceled)
